(19) United States
(12) Patent Application Publication
(10) Pub. No.: US 2008/0018167 A1
(43) Pub. Date: Jan. 24, 2008

(54) Omnidirectionally Moving Wheel, Moving Device, Carrying Device, and Massage Device

(76) Inventor: Shinichiro Fuji, Miyagi (JP)

Correspondence Address: RABIN & Berdo, PC, 1101 14TH STREET, NW, SUITE 500, WASHINGTON, DC, 20005, US

(21) Appl. No.: 11/793,477

(22) PCT Filed: Dec. 13, 2005
(86) PCT No.: PCT/JP05/22854

§ 371 Date: Jun. 20, 2007

(30) Foreign Application Priority Data
Dec. 20, 2004 (JP) 2004-367219
Oct. 7, 2005 (JP) 2005-295781
Oct. 13, 2005 (JP) 2005-299066

(51) Int. Cl. B60B 19/00; A61H 7/00

(52) U.S. Cl. 301/5.23; 280/29; 301/6.1; 601/84

(57) ABSTRACT

An omnidirectionally moving wheel includes multiple rotating bodies and a wheel, wherein each rotating body has a flexibility to be able to bend a rotational axis, is bent to encircle an outer circumference of the wheel in a ring-like shape, and is compressed in a direction of the rotational axis of each rotating body to be disposed on the wheel in a manner to allow rotation centered around each rotating body's secured rotational axis extending along a plane perpendicular to the rotational axis of the wheel.

### FIELD OF THE INVENTION

The present invention relates to an omnidirectionally moving wheel, and a moving device, a carrying device, and a massage device containing the omnidirectionally moving wheel.

### DESCRIPTION OF RELATED ART

Conventionally, a caster is commonly used as a wheel in wheeled platforms, wheel chairs, and the like that can travel while freely changing a direction of motion. At a time when the caster switches the direction of motion from forward to backward, or the like; it is necessary for a wheel to temporarily turn in a direction crossing the direction of motion. At this time, where there is a furrow in the floor surface on which the wheel is placed, the wheel falls into the furrow, which causes accidents in places such as railroad crossings or elevators.

Furthermore, because it is difficult for the wheel to rotate on inhospitable ground such as a gravel road, a bumpy road, soft ground into which the wheel sinks, or a road with deep snow, there is a problem that a large amount of strength is necessary to move the wheel, causing poor mobility. Enlarging a diameter of the wheel has been considered as a means to solving this problem. However, due to the structure of the caster, because of a restriction that it is necessary to enlarge a height of a wheel frame and to ensure an open space around the caster for those times when the wheel changes direction, the enlarging of the wheel is limited. Securing a position of the wheel has been considered as a method of solving the aforementioned problems.

All wheel drive is desirable to improve the mobility, but in such a case, the cost increases by incorporating a forced drive mechanism of the wheel in the structure of the caster changing the direction of the axle in relation to the body of a vehicle. To easily execute the forced driving, a wheel in which the position of the axle does not change in relation to the body of the vehicle is required.

Provided as an example of a vehicle in which the position of the axle is secured is a motorized wheelchair (see Patent Document 1) in which each wheel is operated by an independent motor, multiple piercing pins are disposed on the wheel flange, an axial direction of the axis of each piercing pin is skewed in relation to a position of an axial direction of the axle, and a rotatable wheel is mounted on each piercing pin. The wheels of the aforementioned motorized wheelchair are so-called mecanum wheels, and other types of wheels are known, such as an omni wheel in which the axial direction of the axis of each piercing pin is perpendicular to the axial direction of the wheel. These mecanum wheels and omni wheels solve a problem of the caster in the sense that the direction of motion can change even where the position of the axle is secured, but there are problems such as the large overall width of the wheel and continuous smooth contact between the ground and the outer circumference of the wheel during rotation cannot be ensured where the traveled surface is not smooth and level. Accordingly, there is a problem that, in practice, the aforementioned types of wheels are limited to indoor use.

To solve the aforementioned problems, multiple small rotating bodies containing rotating axes orthogonal to the axles inside identical surfaces are disposed linearly inside a rotating surface of the wheel along the outer circumference of the wheel, so that the wheel can ensure contact between the ground and the outer circumference of the wheel even where the ground is a curved surface or a flat surface made up of multiple other flat surfaces (for example, see Patent Documents 4, 5).

At a time when the small rotating bodies are disposed on the outer circumference of the wheels, however, because adjacent small rotating bodies contact each other, which inevitably causes gaps to arise in the outer circumference of the wheel. Therefore, the outer circumference of the wheel becomes a polygonal shape with many edges, so that smooth rotation cannot be achieved. Furthermore, because the gaps between the small rotating bodies create wedge-shaped openings in the outer circumference of the wheel, the small rotating bodies can become damaged and unable to rotate in a case where a pebble or the like is sandwiched in the gaps. Covering the wedge-shaped gaps of the outer circumference with a cover has been tried as a means of solving the aforementioned problem, but smooth travel cannot be achieved where the cover rides over an uneven projection on the ground, which leads to a strict limitation on the surfaces on which such a wheel can be used.

To minimize the gaps in the outer circumference as much as possible and form the outer circumference in a nearly continuous circular shape, there is a structure in which the small rotating bodies fit internally into the adjacent small rotating bodies (e.g., see Patent Document 2 or 3).

Even in such a wheel, however, to prevent interference caused by the contact of adjacent small rotating bodies and for the rotating bodies to have sufficient thickness to achieve the necessary strength, gaps must be allowed between the adjacent small rotating bodies. Vibration and noise arises from these gaps during travel, and, particularly on a hard and flat floor surface such as indoor flooring or a paved street, significant inconvenience is caused by the vibration and noise. In a case where such a wheel is used in a wheel chair, not only is the ride uncomfortable, but also there is a concern that a user's health is affected, leaving room for improvement in the design of the wheel.

Furthermore, in the omnidirectionally rotating wheels recorded in Patent Documents 1, 2, 3, 4, 5, 6, the rotational axis of each rotating body is an inflexible straight line. In such a case, to form the ring-like shape on the outer circumference of the wheel, it is necessary that each rotating body be formed in a drum-like or bell-like shape in which an outer diameter changes in a direction of the rotational axis of the rotating body. Upon travel through the rotation of each rotating body described above, however, the outer diameter changes depending on the position of the rotational axis of each rotating body, and at a time when the outer diameter is small, the ability of the wheel to ride over an obstruction in the traveled path is extremely low, and there is a further problem that the rotating body slips without rotating in a case where the outer diameter is small.

In the omnidirectionally rotating wheels recorded in Patent Documents 1, 2, 3, 4, 5, because each rotating body can rotate and move in all directions, the wheel moves downwards without operation by the user, or even in opposition to the operation of the user, because of gravity in a case where the ground is sloped. In such a case, there is a problem that straight mobility is worsened and operation becomes unreliable.

Patent Document 1: Japanese Patent Publication No. 3244706

Patent Document 2: Japanese Patent Publication No. 3421290

Patent Document 3: Japanese Patent Application Publication No. 2002-137602

Patent Document 4: Japanese Patent Publication No. 3381848

Patent Document 5: Japanese Patent Application Publication No. 2001-213103

Patent Document 6: Japanese Patent Application Publication No. 2004-344289

### DISCLOSURE OF THE INVENTION

It is an objective of the present invention, in consideration of the technical problems described above, to provide an omnidirectionally moving wheel and moving device having a high ability to ride over an obstruction in the traveled path regardless of the position of the rotational axis of each rotating body that can suppress vibration and noise during travel, increase straight mobility, and achieve reliable operation have good mobility even on inhospitably ground. Furthermore, it is an objective of the present invention to provide a carrying device and a massage device that can execute reliable performance using the omnidirectionally moving wheel.

The omnidirectionally moving wheel according to the present invention contains multiple rotating bodies and a wheel. Each rotating body has flexibility to be able to bend a rotational axis, is bent to encircle an outer circumference of the wheel in a ring-like shape, and is compressed in a direction of the rotational axis of each rotating body to be disposed on the wheel in a manner to allow rotation centered around each rotating body's secured rotational axis extending along a plane perpendicular to the rotational axis of the wheel.

In the omnidirectionally moving wheel according to the present invention, it is desirable that each rotating body is made of a coil spring covered with an elastic body and that the wheel contains rotating body support units to support each rotating body in a rotatable manner at both ends while restricting the shape thereof. In such a case, by choosing the coil spring with a suitable coil diameter and wire material, a sufficient resisting strength in relation to radial compaction of the coil spring. Furthermore, by choosing the coil spring with a suitable free length and number of turns, displacement of the rotational axis of the rotating body caused by a load can be sufficiently minimized, a contour of the outer circumference contacting the ground becomes difficult to brake. There are gaps between the wires of the coil spring because of the bending, which create gaps in the outer side surface of each rotating body, but smooth rotation can be achieved because of the elastic body covering. Because strength to support a load can be achieved by the coil spring and resilience against the ground surface can be achieved by the elastic body, vibration can be suppressed and the ride can be made comfortable while at the same time increasing a load bearing ability.

Furthermore, in the omnidirectionally moving wheel according to the present invention, because each rotating body is mounted on the wheel in a manner allowing rotation centered around each rotating body's secured rotational axis extending along a plane perpendicular to the rotational axis of the wheel, each rotating body can be made to rotate on an axis perpendicular to the rotational axis of the wheel. Therefore, the direction can be switched to an arbitrary direction, even where an axle is secured, so that space for changing a direction of the wheel becomes unnecessary, the diameter of the wheel can be enlarged, and mobility on inhospitable ground can be heightened.

Furthermore, in the omnidirectionally moving wheel according to the present invention, because each rotating body is disposed in a manner to be bent to encircle the outer circumference of the wheel in a ring-like shape, point contact with the ground can be achieved. Therefore, mobility is achieved even where the traveled surface is not continuous and smooth, such as on uneven inhospitable ground or curved surfaces. Furthermore, because each rotating body is bent, each rotating body can be disposed to not overlap with the adjacent rotating body. Therefore, even where each rotating body is formed with a thickness having sufficient strength and elasticity, the gaps between adjacent rotating bodies can be minimized, so that vibration and noise during travel can be suppressed. Because the wheel contains the rotating body support units to support each rotating body in a rotatable manner at both ends while restricting the shape thereof, displacement of the rotational axis of each rotating body can minimized to not effect the comfort of the ride at a time when a load is added. Furthermore, smooth rotation can be achieved because each rotating body can rotate while maintaining the curve of the rotational axis. Because each rotating body is compressed in an axial direction, the durability of the elastic body is increased compared to a time when tensile stress is added to each rotating body. Furthermore, displacement of each rotating body in a direction of the rotational axis and deviation of the rotational axis from the original position along a flat surface caused by the force from contacting the ground can be suppressed.

In the omnidirectionally moving wheel according to the present invention, it is desirable that each rotating body be formed by covering the coil spring with the elastic body in a cylindrical shape.

In the omnidirectionally moving wheel according to the present invention, it is desirable that each rotating body be disposed in a manner such that the outer side surface thereof is connected with the outer side surface of the adjacent rotating body. In such a case, the outer side surface refers to the surface of the rotating body contacting the ground, and when connected as described above, there are still many small, but the gaps are so small that the shape is almost continuous. In such a case, the gaps between the outer side surfaces of adjacent rotating bodies are small, vibration and noise caused by the gaps during travel can be suppressed. Furthermore, by ensuring suitable gaps in the wheel side surface of the rotating body, a roll support column has a wedge-shaped cross section that can ensure sufficient strength.

It is desirable that the omnidirectionally moving wheel according to the present invention contain multiple core members, that each rotating body be made of a cylindrical body, that each core member be inserted into an internal portion of each rotating body, and that both ends of each rotating body be engaged with the rotating body support unit. In such a case, the bent shape of the rotating body can be forced into the desirable shape by the shape of the core member, so that significant displacement can be suppressed and the effect on the comfort of the ride can be minimized by the support of the internal wall of the rotating body, even where a heavy load is added to each rotating body. Furthermore, damage caused by excessive deformation can be prevented. It is desirable that a space between the internal wall of each rotating body and the core member be supported by a bearing or the like to allow rotation.

In the omnidirectionally moving wheel according to the present invention, the wheel may contain multiple boards for filling the gaps between two adjacent rotating bodies. In such a case, the boards prevent foreign objects such as pebbles from being sandwiched in the gaps between two adjacent rotating bodies. Therefore, problems such as a worsening of the rotation of the rotating bodies, a worsening of the comfort of the ride, or damage to the rotating body or the wheel can be prevented.

In the omnidirectionally moving wheel according to the present invention, the wheel may be made of a wheel body and multiple rotating body support units, each rotating body may be made of a cylindrical body, and each rotating body support unit may be secured radially on the outer circumference of the wheel body and disposed between each set of two adjacent rotating bodies to support the rotating bodies at an internal circumference of both ends in a manner allowing rotation. In such a case, because unity of the wheel and each rotating body is increased, vibration and noise during travel is suppressed and comfortable travel can be ensured.

In the omnidirectionally moving wheel according to the present invention, it is desirable that the rotating body be made by covering the coil spring with the elastic body in a cylindrical shape, and that the elastic body contain furrows on an internal surface of the cylinder along the gaps in the coil spring. In such a case, intervals between the wires of the coil spring can be easily shrunk by the furrows in the inner side surface of each rotating body at a time when each rotating body is bent. Therefore, each rotating body can be easily bent so that each rotating body can rotate easily. With such a structure, in comparison to a case where a material with large volume compressibility is used as the elastic body to make each rotating body easily bendable, the cost of the material can be decreased. Such a structure is particularly useful in a case where mass production of the furrowing process is possible. In a case where mass production of the furrowing process is difficult, however, it is desirable that material with a sufficiently small displacement resistance of volume compressibility be used without furrows.

In the omnidirectionally moving wheel according to the present invention, each rotating body may contain a cylindrical surface, a surface continuously bent convexly from an end portion to a central portion, or a surface in which the central portion is continuously bent convexly and both ends are fattened to form a concave shape. In such a case, by changing the shape of the surface of the rotating body, the outer circumference of the omnidirectionally moving wheel becomes closer to a perfect circle during travel without a load, thereby achieving smoother travel. Furthermore, where a load is added to the rotating body, the portion of the wheel contacting the ground becomes more circular, so that smoother rotation can be achieved,

In the omnidirectionally moving wheel according to the present invention, it is desirable that each rotating body contain an anisotropic structure in strength having flexibility and resistance to bowing in a direction perpendicular to the rotational axis.

In the omnidirectionally moving wheel according to the present invention, the structure included in each rotating body be made of a bellows that can expand and contract in a direction of the rotational axis. Furthermore, the structure included in the rotating body may be a roughly cylindrical shape containing multiple grooves interspersed opposite to the cylindrical diameter, where each groove is disposed to cut radially from an outer circumferential surface of the structure and is disposed to allow space between the adjacent groove in a direction of the rotational axis, so that each rotating body has flexibility to bend the rotational axis. The structure included in each rotating body may be made of a coil spring of a modified cross section wire material. The structure included in each rotating body is made of a spring formed in a shape of a coil spring by cutting work. The structure included in the rotating body may contain multiple coil springs having the same diameter and pitch disposed to match the central axis in a manner to allow other coil springs to be disposed in the space between the wires of the aforementioned coil springs. The structure included in the rotating body may be made of a coil spring with a large diameter and a coil spring with an outer diameter smaller than the inner diameter of the coil spring with a large diameter, where the coil spring with the small diameter is disposed inside of the coil spring with the large diameter. The structure included in the rotating body may contain multiple projections on the outer circumference to stop slipping. The structure included in the rotating body may contain a plastic coil spring and a plastic film attached in a cylindrical shape, on an internal side of the coil spring to cover the gaps thereof. The structure included in the rotating body may be made of a coil spring.

In addition, in the omnidirectionally moving wheel according to the present invention, the rotating body may be made of the aforementioned structure and an elastic body having resilience against a ground surface. Each rotating body may be made by covering an outer circumference of the flexible structure with the elastic body in a roughly cylindrical shape. Each rotating body may be made by covering the structure with the elastic body in a roughly cylindrical shape. Each rotating body may be made by covering the wires of the structure with the elastic body. Each rotating body may contain furrows on an outer surface of the elastic body. The rotating body may contain furrows on at least one of an outer surface or an inner surface of the elastic body. The rotating body may contain a bumpy tread pattern formed on an outer surface of the elastic body.

In the omnidirectionally moving wheel according to the present invention, it is desirable that the rotating body be formed by covering a flexible structure with an elastic body in a roughly cylindrical shape, that the rotating body contain furrows disposed along the gaps in an inner wall of the elastic body, and that the furrows are disposed circumferentially along an outer surface in a spiral pattern.

In the omnidirectionally moving wheel according to the present invention, in a case where the omnidirectionally moving wheel is designed in such a manner that the diameter of the rotating body is large in relation to the outer diameter of the wheel, the rotating body may contain a surface continuously bent convexly from an end portion to a central portion or a surface in which the central portion is continuously bent convexly and both ends are fattened to form a concave shape. Through such a shape, a wheel with a very small diameter can be realized, as well as a wheel with a same diameter having a change in diameter smaller than the change in diameter of an inflexible rotating body. In such a case, in the omnidirectionally moving wheel according to the present invention can be designed in a manner such that the outer diameter of each rotating body changes, but the minimal inner diameter permissible for the intended use can be ensured.

In the omnidirectionally moving wheel according to the present invention, it is desirable that the rotating body be made of an elastic body having furrows on at least either an outer side or an inner side.

In the omnidirectionally moving wheel according to the present invention, the rotating body may be a structure made by joining multiple tire-shaped elastic bodies in a direction of the axis of rotation thereof. In such a case, an inner circumferential surface of the tire-shaped elastic body is formed to contain circular cavities centered around a rotational axis of the tire-shaped elastic body.

In the omnidirectionally moving wheel according to the present invention, each rotating body may be made by joining multiple rings disposed in a parallel manner with space therebetween and covering the outer circumference of each ring with an elastic body in a cylindrical shape.

In the rotating body of the omnidirectionally moving wheel according to the present invention, it is desirable that the structure be a roughly cylindrical shape containing multiple grooves interspersed opposite to the cylindrical diameter, where each groove is disposed to cut radially from an outer circumferential surface of the structure and is disposed to allow space between the adjacent groove in a direction of the rotational axis.

In the rotating body of the omnidirectionally moving wheel according to the present invention, it is desirable that the structure be made of a coil spring of a modified cross section wire material.

In the rotating body of the omnidirectionally moving wheel according to the present invention, it is desirable that the structure be made of a spring formed in a shape of a coil spring by cutting work.

In the rotating body of the omnidirectionally moving wheel according to the present invention, it is desirable that the structure contain multiple coil springs having the same diameter and pitch disposed to match the central axis in a manner to allow other coil springs to be disposed in the space between the wires of the aforementioned coil springs.

In the rotating body of the omnidirectionally moving wheel according to the present invention, it is desirable that the structure be made of a coil spring with a large diameter and a coil spring with an outer diameter smaller than the inner diameter of the coil spring with a large diameter, where the coil spring with the small diameter is disposed inside of the coil spring with the large diameter.

In the rotating body of the omnidirectionally moving wheel according to the present invention, it is desirable that the structure contain multiple projections on the outer circumference to stop slipping.

In the rotating body of the omnidirectionally moving wheel according to the present invention, it is desirable that the structure contain a plastic coil spring and a plastic film attached in a cylindrical shape on an internal side of the coil spring to cover the gaps thereof.

In the rotating body of the omnidirectionally moving wheel according to the present invention, it is desirable that the structure be made of a coil spring.

In the omnidirectionally moving wheel according to the present invention, the outer circumference of the wheel can be formed in a ring-like shape even where each rotating body is formed in a roughly cylindrical shape. Therefore, without changing the outer diameter in a direction of the rotational axis of each rotating body, objects obstructing the path on which the omnidirectionally moving roller travels can always be ridden over by the portion of the rotating body having the largest diameter, so that the ability to ride over an obstruction can always be exhibited to the maximum amount. Through the manner described above, the omnidirectionally moving roller has a high ability to ride over an obstruction in the traveled path, regardless of the position of the direction of the rotational axis of each rotating body.

Because each rotating body is disposed on the wheel in a manner such that the rotating body can rotate centered around each rotating body's secured rotational axis extending along a plane perpendicular to the rotational axis of the wheel, each rotating body can rotate in a direction perpendicular to the rotational direction of the wheel, thereby allowing turning in an arbitrary direction even where the axle is secured in a case where the omnidirectionally moving wheel is used as a wheel. Therefore, space is not necessary to change the direction of the motion of the wheel and the diameter of the wheel can be enlarged to increase mobility over inhospitable ground. Furthermore, a driving mechanism can be easily incorporated because the axle position does not change, and mobility can be further increased in such a case.

Because each rotating body is bent to encircle the outer circumference of the wheel in a ring-like manner, the omnidirectionally moving wheel can achieve point contact with the ground, so that mobility is achieved even where the traveled surface is not continuous and smooth, such as on uneven inhospitable ground or curved surfaces. Because each rotating body is compressed in the direction of the rotational axis, durability is increased compared to a time when tensile stress is added to each rotating body. Furthermore, displacement of each rotating body in a direction of the rotational axis or change in the amount of bowing in the arc of the rotational axis caused by a reactive force of the ground can be suppressed.

In the omnidirectionally moving wheel according to the present invention, each rotating body has a resisting force against compression in a radial direction. Furthermore, it is desirable that each rotating body have both a structure that can carry a load in a pressing in radial direction and an elastic function demonstrating resilience during contact with the ground.

It is desirable that the omnidirectionally moving wheel according to the present invention contain the wheel, the rotating body, and rotating body support units to support each rotating body in a rotatable manner at both ends while restricting the shape thereof. In such a case, at a time when the load is added to each rotating body, displacement of the rotational axis can be minimized so as not to negatively affect the comfort of the ride. Furthermore, each rotating body can rotate while maintaining curvature of the rotational axis. Particularly in a case where the load placed on each rotating body is light, the rotating body can be made light weight and the cost can be reduced by using such an abbreviated structure.

The omnidirectionally moving wheel according to the present invention may contain the core member inserted into an internal portion of each rotating body, where both ends of the core member are connected to the rotating body support unit. In such a case, the bent shape of the rotating body can be forced into the desirable shape by the shape of the core member, so that significant displacement can be suppressed and the effect on the comfort of the ride can be minimized by the support of the internal wall of the rotating body, even where a heavy load is added to each rotating body. Furthermore, damage caused by excessive deformation can be prevented. Because each rotating body can be constructed in a bent shape because of the core member, spare parts can be prepared in advance. Therefore, in the rare case where it is necessary to replace the rotating body because of damage or the like, each rotating body can be easily replaced using simple tools, so that maintenance and repairs can be performed by a user, thereby ensuring quick maintenance at a reduced cost.

In the omnidirectionally moving wheel according to the present invention, the core member may be disposed in a prescribed location at both ends of each rotating body, and may include an intermediate support unit material to support each rotating body in a manner to allow rotation. In such a case, deformation of each rotating body at a time when an excessively heavy weight is added can be further suppressed. Furthermore, by forcing the each rotating body into the prescribed shape at the time of construction, the shape of the outer circumference of the wheel can be reformed to a shape closely resembling a perfect circle, so that vibration during travel caused by the rotation of a polygonal shape at a time when no load is added can be reduced. By lengthening the dimensions of each rotating body, the number of rotating body support units disposed can be decreased to improve the design and reduce the cost. It is desirable that the intermediate support unit material be made of a bearing, such as a rolling bearing or sliding bearing.

In the omnidirectionally moving wheel according to the present invention, the wheel may contain a wheel body with a small diameter located on a central axis and multiple spokes connecting the wheel body to the rotating body support unit. Because the rotating body support unit is held and centered around the wheel by the spokes, the series of parts formed in a ring-like shape including the core member, the rotating body support units, and the like, can be formed as a single solid ring that can bear a load by pressing and binding each part at the end surfaces in a radial direction of the wheel. In such a case, at a time when the omnidirectionally moving wheel with a large diameter is constructed, the rotating body support unit can be supported by the wheel body with a small diameter and the multiple spokes, so that the structure can be made very light weight because the wheel body with a large diameter is not necessary. Furthermore, a rim, formed by arranging the rotating body support units in the ring-like shape on the outer circumference, may be disposed, so that the rim is connected to the wheel with the small diameter by the spokes. In such a case, the wheel can achieve a larger load bearing ability.

The omnidirectionally moving wheel according to the present invention may contain a sealing unit to fill openings at both ends of each rotating body unit. In such a case, even where traveling over sand or gravel, the sand or gravel can be prevented from entering into the gaps or internal portions of each rotating body. Therefore, a condition can be prevented in which greater force is necessary for travel because of an increase in the amount of energy lost in rotation as a result of sand or gravel entering into the gaps or internal portions of each rotating body. It is desirable that the sealing unit be made of a seal ring, which is a metal or plastic disc spring structure. Furthermore, the sealing pressure of the sealing unit can be adjusted by compressing the height of the disc spring.

In the omnidirectionally moving wheel according to the present invention, it is desirable that the rotating body include a brake, which is mounted on the wheel in a manner to selectively secure or rotate each rotating body. The omnidirectionally moving wheel can be selected to function as a secured wheel that can only move backwards and forwards or to function as a free-moving wheel that can move in all directions, according to the condition in which the omnidirectionally moving wheel is used. Therefore, even in a case of a slanted road, each rotating body can be secured to go straight so that the moving device does not move downward because of gravity. In the manner described above, the omnidirectionally moving wheel can increase straight forward mobility while allowing safe operation.

The omnidirectionally moving wheel according to the present invention is very effective when used as the wheel in, for example, a sales cart used inside trains that must move safely up and down a narrow isle while sometimes moving to the side to avoid an obstruction, a transport platform used inside a factory that must assume difficult positions to transfer shipments of goods, a wheel chair selected for good workability such as being able to move sideways a small amount when facing a desk, or the like.

In the omnidirectionally moving wheel according to the present invention, it is desirable that the brake comprises multiple brake shoes, a cam ring, and an operation unit, that each brake shoe contains a cam follower and is disposed on an outer circumference of the wheel in a manner allowing movement between a stopped position contacting each rotating body and a released position separated from each rotating body, that the cam ring is disposed on the wheel in a manner allowing rotation around a rotational axis of the wheel, is joined to each cam follower, and has a cam shape that can selectively move the brake shoe between the stopped and released positions according to a degree of rotation in relation to the wheel, and that the operation unit is disposed to be able to rotate the cam ring in relation to the wheel. In such a case, when the cam ring is made to rotate in relation to the wheel by the operation unit, the brake shoe can be selectively moved to a stopping position or a releasing positing according to the angle of rotation of the cam wheel in relation to the wheel 303 and the cam follower joined to the cam ring. At a time when the brake shoe is in the stopping position, the brake shoe contacts each rotating body to secure each rotating body to prevent rotation thereof centered around the rotational axis of each rotating body. At a time when the brake shoe is in the releasing position, the brake shoe is removed from each rotating body to allow rotation centered around the rotational axis of each rotating body.

The moving device according to the present invention contains on a main body the omnidirectionally moving wheel according to the present invention. The moving device according to the present invention has little vibration or noise and also has good mobility even on inhospitable ground because of the omnidirectionally moving wheel. Furthermore, the moving device according to the present invention can change direction to any arbitrary direction while keeping the rotational axis of the omnidirectionally moving wheel secured.

Because the moving device according to the present invention contains the omnidirectionally moving wheel according to the present invention, the moving device has a high ability to ride over an obstruction in the traveled path, regardless of the position of the direction of the rotational axis of each rotating body. Furthermore, because each rotating body can selectively be secured or allowed to rotate by the brake, straight forward mobility can be increased while allowing safe operation. The moving device according to the present invention can be suitably used in a sales cart used inside a train, a transport platform used inside a factory, a wheel chair, or the like.

It is desirable that the moving device according to the present invention contain a main body, a pair of secured wheels, and at least one or more omnidirectionally moving wheel according to the present invention. In the moving device according to the present invention, it is desirable that the secured wheels be mounted rotatably to the main body on a secured axial direction and the omnidirectionally moving wheel be rotatably mounted on the main body to support the main body along with the secured wheels. The moving device according to the present invention has little vibration or noise and also has good mobility even on inhospitable ground because of the omnidirectionally moving wheel. Furthermore, the moving device according to the present invention can change direction to any arbitrary direction while keeping the rotational axis of the omnidirectionally moving wheel secured.

In the moving device according to the present invention, it is desirable that the secured wheel and the omnidirectionally moving wheel are disposed at corners of a rectangular body. In such a case, supporting balance of the main body is good, as is safety during travel. Furthermore, the position of the secured wheels and the omnidirectionally moving wheels allows easy access to both wheels, thereby allowing easy operation.

The moving device of the present invention may contain two transfer belts wrapped around the secured wheel and the omnidirectionally moving wheel to form two pairs thereof. In such a case, because the secured wheels and the omnidirectionally moving wheels can be made to rotate in unison, the moving device becomes four-wheel drive and has good safety and mobility. Furthermore, with four-wheel drive, the moving device can easily travel over sandy or stepped surfaces.

Furthermore, the omnidirectionally moving wheel according to the present invention is not limited to use as a wheel in a moving device, but can also be used as a roller in a carrying device or a kneading ball in a massage device.

The carrying device according to the present invention is a carrying device for carrying goods, which contains the omnidirectionally moving wheel as a carrying roller. The massage device according to the present invention contains the omnidirectionally moving wheel as a kneading ball for massaging. Because such a massage device can benefit from the affect of the omnidirectionally moving wheel according to the present invention, the massage operation of moving up, down, left, and right while applying pressure is possible, as is lateral movement.

### BRIEF DESCRIPTION OF THE DRAWINGS

FIG. 1 is a perspective view showing an omnidirectionally moving wheel according to a first embodiment;

FIG. 2 is cross sectional view of parts of the omnidirectionally moving wheel shown in FIG. 1. A diagram of a coil spring forming the rotating body structure is omitted;

FIG. 3 is a perspective view showing a roll support column of the omnidirectionally moving wheel shown in FIG. 1;

FIG. 4 is a perspective view showing a coil spring of the omnidirectionally moving wheel shown in FIG. 1;

FIG. 5 is a vertical cross sectional view showing a rotating body of the omnidirectionally moving wheel shown in FIG. 1;

FIG. 6 is a perspective view showing a bent condition of the rotating body of the omnidirectionally moving wheel shown in FIG. 1. A diagram of a coil spring forming the rotating body structure is omitted;

FIG. 7 is a vertical cross sectional view showing a bent condition of the rotating body of the omnidirectionally moving wheel shown in FIG. 1;

FIG. 8 is a perspective view showing an omnidirectionally moving roller according to a second embodiment of the present invention;

FIG. 9 is a vertical cross sectional view showing a rotating body of the omnidirectionally moving roller shown in FIG. 8;

FIG. 10 is a vertical cross sectional view showing the rotating body, a core member, and a cap of the omnidirectionally moving roller shown in FIG. 8. The following is a case where a diagram of a structure, such as a bellows, formed on an internal surface of the rotating body is omitted;

FIG. 11 is a vertical cross sectional view showing an example variation where a core member is not contained in the omnidirectionally moving wheel shown in FIG. 8;

FIG. 12 is a vertical cross sectional view showing an example variation where an intermediate support unit material is contained in the omnidirectionally moving wheel shown in FIG. 8;

FIG. 13 is a front view showing an example variation where spokes are contained in the omnidirectionally moving wheel shown in FIG. 8;

FIG. 14 is a vertical cross sectional view showing an example variation where a sealing unit is contained in the omnidirectionally moving wheel shown in FIG. 8;

FIG. 15 is a vertical cross sectional view showing an example variation 1 of the rotating body of the omnidirectionally moving wheel shown in FIG. 8;

FIG. 16 is a vertical cross sectional view showing an example variation 2 of the rotating body of the omnidirectionally moving wheel shown in FIG. 8;

FIG. 17 is a perspective view showing an example variation 3 of the rotating body of the omnidirectionally moving wheel shown in FIG. 8;

FIG. 18 is a vertical cross sectional view showing an example variation 4 of the rotating body of the omnidirectionally moving wheel shown in FIG. 8;

FIG. 19 is a vertical cross sectional view showing an example variation 5 of the rotating body of the omnidirectionally moving wheel shown in FIG. 8;

FIG. 20 is a vertical cross sectional view showing an example variation 6 of the rotating body of the omnidirectionally moving wheel shown in FIG. 8;

FIG. 21 is a vertical cross sectional view showing an example variation 7 of the rotating body of the omnidirectionally moving wheel shown in FIG. 8;

FIG. 22 is a vertical cross sectional view showing an example variation 8 of the rotating body of the omnidirectionally moving wheel shown in FIG. 8;

FIG. 23 is a vertical cross sectional view showing an example variation 9 of the rotating body of the omnidirectionally moving wheel shown in FIG. 8;

FIG. 24 is a vertical cross sectional view showing an example variation 10 of the rotating body of the omnidirectionally moving wheel shown in FIG. 8;

FIG. 25 is a vertical cross sectional view showing an example variation 11 of the rotating body of the omnidirectionally moving wheel shown in FIG. 8;

FIG. 26 is a vertical cross sectional view showing an example variation 12 of the rotating body of the omnidirectionally moving wheel shown in FIG. 8;

FIG. 27 is a vertical cross sectional view showing an example variation 13 of the rotating body of the omnidirectionally moving wheel shown in FIG. 8;

FIG. 28 is a vertical cross sectional view showing an example variation 14 of the rotating body of the omnidirectionally moving wheel shown in FIG. 8;

FIG. 29 is a vertical cross sectional view showing an example variation 15 of the rotating body of the omnidirectionally moving wheel shown in FIG. 8;

FIG. 30(a) is a vertical cross sectional view of the rotating body showing an example variation 16 of the rotating body of the omnidirectionally moving wheel shown in FIG. 8;

FIG. 30(b) is a general view showing an example variation 16 of the rotating body of the omnidirectionally moving wheel shown in FIG. 8;

FIG. 31 is a vertical cross sectional view showing an example variation 17 of the rotating body of the omnidirectionally moving wheel shown in FIG. 8;

FIG. 32 is a vertical cross sectional view showing an example variation 18 of the rotating body of the omnidirectionally moving wheel shown in FIG. 8;

FIG. 33(a) is a front view showing an omnidirectionally moving wheel according to a third embodiment of the present invention;

FIG. 33(b) is a front view showing a condition where a cam ring holder is removed in the omnidirectionally moving wheel according to the third embodiment of the present invention

FIG. 34(a) is an A-A cross sectional view of the omnidirectionally moving wheel shown in FIG. 33;

FIG. 34(b) is an exploded cross sectional view of a brake of the omnidirectionally moving wheel shown in FIG. 33;

FIG. 35 is an exploded front view of the brake in a condition where the cam ring is removed in the omnidirectionally moving wheel shown in FIG. 33;

FIG. 36(a) is a front view showing the cam ring of the omnidirectionally moving wheel shown in FIG. 33;

FIG. 36(b) is an exploded front view of a cam shape showing the cam ring of the omnidirectionally moving wheel shown in FIG. 33;

FIG. 37(a) is a cutaway lateral view showing a condition where the omnidirectionally moving wheel shown in FIG. 33 is used in a sales cart for use in a train carriage;

FIG. 37(b) is a cutaway rear view showing a condition where the omnidirectionally moving wheel shown in FIG. 33 is used in a sales cart for use in a train carriage; and

FIG. 38 is a lateral view showing a condition where the omnidirectionally moving wheel shown in FIG. 33 is used in a wheel chair.

### PREFERRED EMBODIMENTS

### First Embodiment

The following is a description of embodiments of the present invention, referencing diagrams.

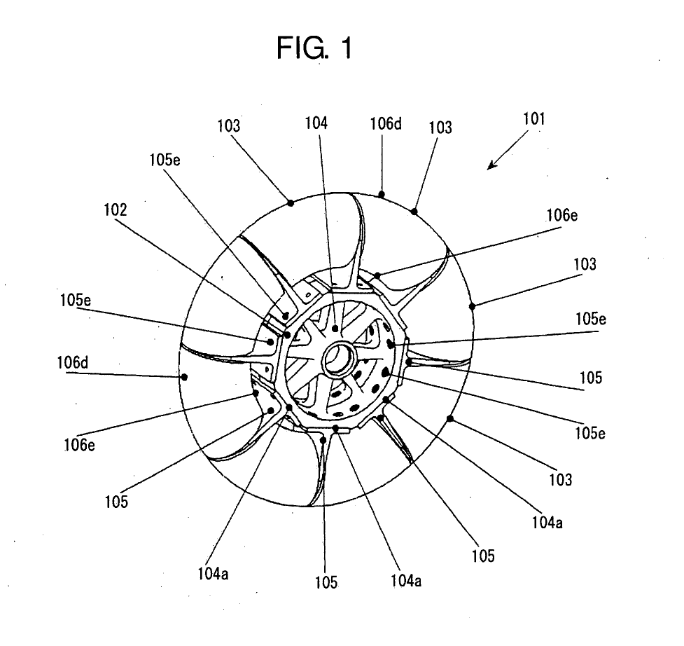

A first embodiment of the present invention is described hereinafter. FIGS. 1 to 7 show an omnidirectionally moving wheel according to an embodiment of the present invention. As shown in FIG. 1, an omnidirectionally moving wheel 101 contains a wheel 102 and multiple rolls 103.

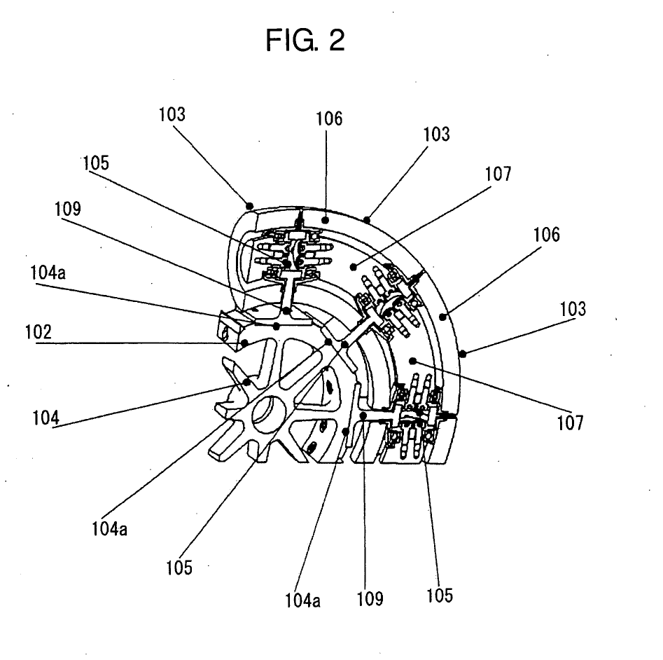

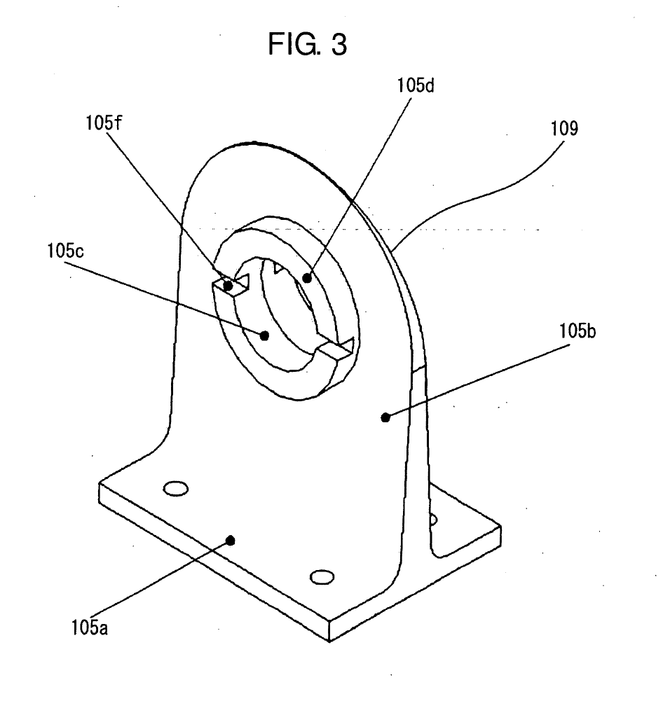

As shown in FIGS. 1 to 3, the wheel 102 is made of metal or plastic and contains a wheel body 104 and eight rotating body support units 105. As shown in FIG. 1, the wheel body 104 contains eight rectangular support unit securing surfaces 104a on the outer circumference. As shown in FIGS. 2 and 3, each rotating body support unit 105 contains a securing board 105a, which is a rectangular board slightly smaller than each support unit securing surface 104a of the wheel body 104, and a support board 105b extending perpendicularly from a center of the securing board 105a. The support board 105b, having a wedge shaped cross section, contains a rotating body securing hole 105c disposed in the center of the support board 105b and a circular support protrusion 105d disposed around a perimeter of the rotating body securing hole 105c. The circular support protrusion 105d contains two notches 105f.

As shown in FIGS. 1 and 2, the securing board 105a of each rotating body support unit 105 is mounted and secured by a screw 105e to each support unit securing surface 104a of the wheel body 104, so that the support board 105b is perpendicular with respect to the rotating direction of the wheel body 104. Each rotating body support unit 105 is secured to the outer circumference of the wheel body 104 in a radial manner.

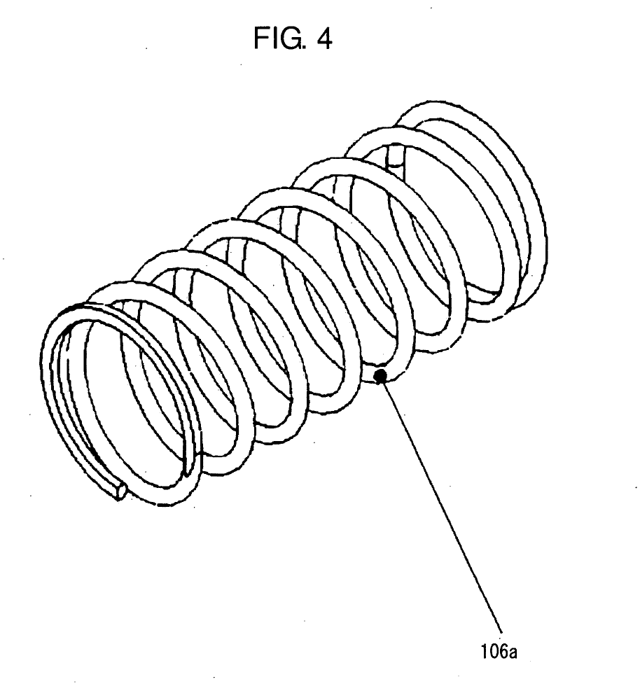

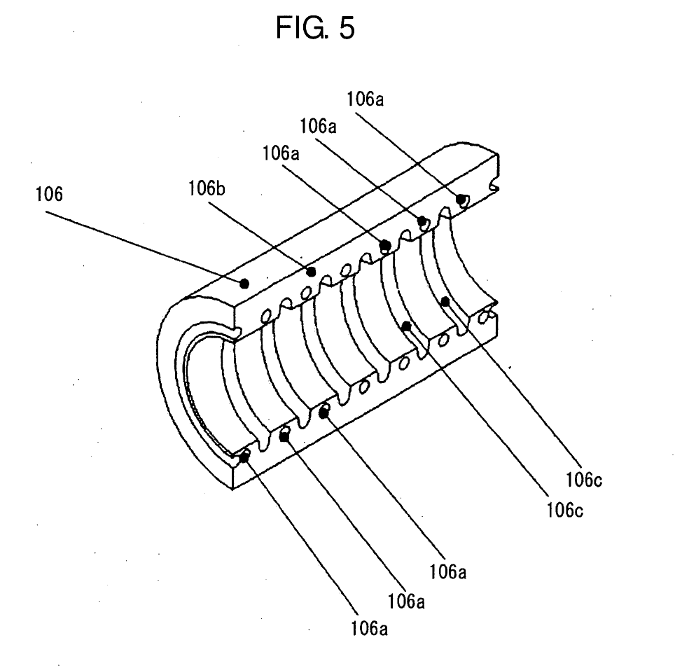

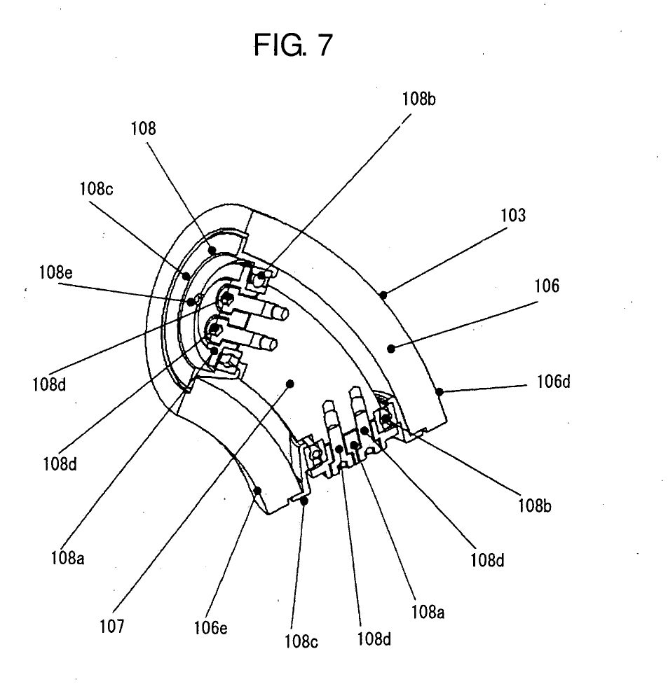

As shown in FIG. 1, there are eight rolls 103, and as shown in FIGS. 4 through 7, each roll 103 contains a rotating body 106, a core member 107, and a pair of caps 108. As shown in FIGS. 4 and 5, the rotating body 106 is formed by covering a coil spring 106a with an elastic body 106b in a cylindrical shape. The elastic body 106b is made up of, for example, polyurethane, silicon rubber, foam rubber, or the like. As shown in FIG. 4, to achieve a sufficient resisting force in relation to radial compaction, a coil spring 106a to be used is chosen having the wire diameter, coil diameter, number of turns, and free length appropriate to the objective of using the omnidirectionally moving wheel 101. As shown in FIG. 5, each rotating body 106 contains a furrow 106c on an internal surface of the cylinder of the elastic body 106b along the gaps of the coil spring 106a. Each rotating body 106 has flexibility to be able to bend the rotating axis. In addition, the description of the coil spring 106a and the furrows 106c has been omitted in FIG. 7.

As shown in FIGS. 2 and 7, the core member 107 is bent to be shaped as a cylindrical arc. The core member 107 has a diameter smaller than an internal diameter of the rotating body 106, and is inserted inside the rotating body 106 so that a gap is created between the core member 107 and an inner wall of the rotating body 106.

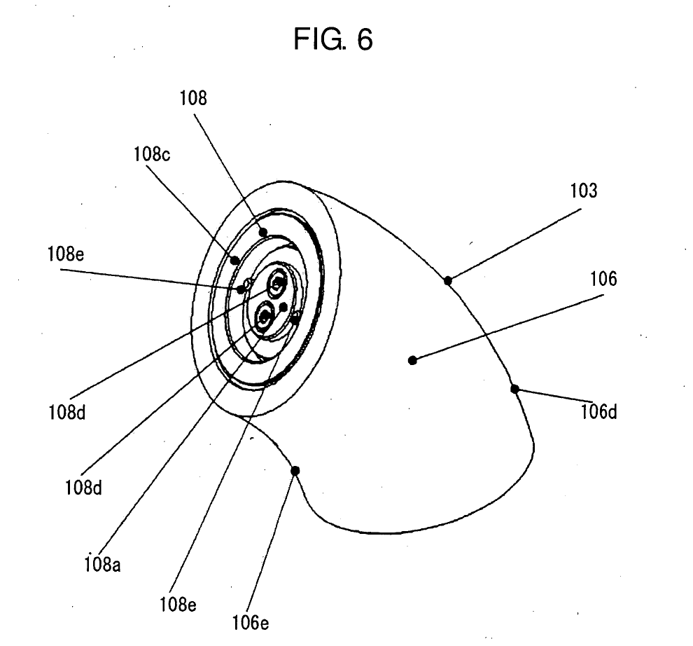

As shown in FIGS. 6 and 7, each cap 108 is cylindrical and contains at a center a central securing unit 108a, which can fit into the rotating body securing hole 105 and the circular support protrusion 105d, and a rotating circumferential unit 108c disposed around the circumference of the central securing unit 108a via a bearing 108b. Each cap 108 is mounted on both ends of the rotating body 106 to close up openings therein. In each cap 108, the central securing unit 108a is secured to the core member 107 by a screw 108d and the rotating circumferential unit 108c is secured to an end portion of the rotating body 106, so that the rotating body 106 is structured in a manner to smoothly rotate along with the rotating circumferential unit 108c in relation to the core member 107 and the central securing unit 108a of the cap 108. The central securing unit 108a contains two engaging projections 108e that are engageable with each notch 105f of the circular support protrusion 105d at a time when the central securing unit 108a fits into the rotating body securing hole 105c. As shown in FIG. 3, a roll support column 109 is formed of the securing board 105a, the support board 105b, the rotating body securing hole 105c, the circular support protrusion 105d, the screw 105e, and the furrows 105f. The rotating body support unit 105 is formed of the roll support column 109 and the cap 108.

As shown in FIGS. 1 and 2, each roll 103 is bent to encircle the outer circumference of the wheel 102 in a ring-like manner and is disposed between each set of two roll support columns 109. Each roll 103 is secured by fitting the central securing unit 108a of the cap 108 into the rotating body hole 105c, so that each engaging projection is engaged with each notch 105f. By engaging each engaging projection 108e in each notch 105f, the central securing unit 108a of the cap 108 and the core member 107 no longer rotate with the rotating body 106. Each roll 103 is pressed between each set of two roll support columns 109, so that the rotating body 106 and the core member 107 are held in the shape of a cylinder bent into an arc. Furthermore, both ends of each rotating body 106 are each supported by two rotating body support units 105. Each rotating body 106 is disposed on the wheel 102 in a manner such that the rotating body 106 can rotate centered each rotating body's secured rotational axis extending along a plane perpendicular to the rotational axis of the wheel 102.

The rotating body 106 is compressed in the axial direction and mounted to each roll 103. As shown in FIG. 1, in each rotating body 106, an outer side surface 106d is disposed to almost be continuous with another outer side surface 106d of the adjacent rotating body 106. In each rotating body 106, the gaps between the adjacent rotating bodies 106 from a wheel side surface 106e to the outer side surface 106d are almost filled by each rotating body support unit 105.

Next, an operation is described. In the omnidirectionally moving wheel 101, because each rotating body 106 is disposed on the wheel 102 in a manner such that the rotating body 106 can rotate centered around each rotating body's secured rotational axis extending along a plane perpendicular to the rotational axis of the wheel 102, each rotating body 106 can rotate in a direction perpendicular to the rotational direction of the wheel 102, thereby allowing turning in an arbitrary direction even where the axle is secured. Therefore, space is not necessary to change the direction of the motion of the wheel and the diameter of the wheel can be enlarged to increase mobility over inhospitable ground.

Because each rotating body 106 is bent to encircle the outer circumference of the wheel 102 in a ring-like manner, the omnidirectionally moving wheel 101 can achieve point contact with the ground, so that mobility is achieved even where the traveled surface is not continuous and smooth, such as on uneven inhospitable ground or curved surfaces. Furthermore, because each rotating body 106 is bent, each rotating body 106 can be disposed in a manner to not overlap the adjacent rotating body 106. Therefore, even though each rotating body 106 is formed with a radial thickness having sufficient strength and elasticity, the gaps between adjacent rotating bodies 106 can be minimized to suppress vibration and noise during travel.

Because the coil spring 106a is covered with an elastic body 106b in a cylindrical shape in each rotating body 106, the distance between the wires of the coil spring 106a at the outer side surface 106d of each rotating body 106 is widened by the bending, but the rotating body 106 can smoothly rotate because of the elastic body 106b. Because the strength to support a load is achieved by the coil spring 106a and springiness during contact with the ground is achieved by the elastic body 106b, a load bearing capacity is increased and vibration is suppressed during travel, resulting in a comfortable ride.

Because the gap between adjacent rotating bodies 106 is small, vibration and noise caused by the gaps during travel can be suppressed. Furthermore, because the gaps are almost filled, foreign objects such as small stones can be prevented from being sandwiched in the gap between the two adjacent rotating bodies 106. Therefore, problems such as a worsening of rotation, a worsening of the comfort of the ride, or damage to the rotating body 106 or wheel 102 can be prevented. Because the core member 107 is inserted inside the rotating body 106, displacement of the rotating body 106 can be suppressed and a negative effect on the comfort of the ride can be minimized even where a heavy load is temporarily added to the rotating body 106. Furthermore, damage to the rotating body 106 due to large deformation can be prevented.

Because each rotating body 106 contains the furrow 106c on the internal surface of the cylinder of the elastic body 106b along the gaps of the coil spring 106a, at a time when each rotating body 106 is bent, the space between the wires of the coil spring 106a can easily be shrunk by the furrows 106c on the inner side surface of the rotating body 106. Therefore, each rotating body 106 can bend and rotate easily. Furthermore, in comparison to a case where a material with large volume compressibility is used as the elastic body 106b to make each rotating body 106 easily bendable, there is a wider range of material to choose from, so that the cost of the material can be decreased.

Because each rotating body 106 is compressed in an axial direction, the durability of the elastic body 106b is high compared to a time when tensile stress is added to each rotating body 106. Furthermore, displacement of each rotating body 106 in a direction of the rotational axis and bowing of the rotational axis caused by the force from contacting the ground can be suppressed. Furthermore, because unity of the wheel 102 and each rotating body 106 is increased, vibration and noise during travel is suppressed to ensure more comfortable travel.

In addition, the omnidirectionally moving wheel 101 may contain a bearing between the inner wall of the rotating body 106 and the core member 107. In such a case, at a time when the load is added to each rotating body 106, displacement of the rotational axis can be minimized so as not to negatively affect the comfort of the ride. Furthermore, each rotating body 106 can rotate while maintaining curvature of the rotational axis. To make wheel 102 lightweight, instead of securing the roll support column 109 to the support unit securing surface 194a with a screw, the omnidirectionally moving wheel 101 may be formed in a manner similar to a bicycle wheel in which the roll support column 109 is bound to the center by spokes.

Furthermore, in the omnidirectionally moving wheel 101, each rotating body 106 may be formed by covering an outer side of the elastic body 106b with a wear-resistant coating material in a block pattern, the elastic body 106 covering the coil spring 106a. Therefore, the durability of each rotating body 106 increases and mobility on snowy ground and the like is also increased. Furthermore, by forming the block pattern at an angle to the rotational axis of the wheel 102, vibration caused by the block pattern can be prevented. The block pattern may be formed without having a covering material, by carving into the elastic body 106b.

The omnidirectionally moving wheel 101 according to this embodiment of the present invention is used for a moving device, such as a wheel chair. For example, it is preferable that the moving device contain a main body, a pair of secured wheels, and a pair of omnidirectionally moving wheels 101, and be structured in a manner such that the secured wheels are secured to the main body in an axial direction in a rotatable manner, and the omnidirectionally moving wheels 101 are mounted on the main body in a rotatable manner to support the main body together with the secured wheels. Such a moving device has good mobility over inhospitable ground because the omnidirectionally moving wheel 101 allows the wheel having a sufficiently large diameter for mobility to be chosen since there is no need to consider the space to change the direction or interference between the legs of the passenger and the caster wheel, which are caused by using the caster wheel. Furthermore, the moving device, in a condition where the axles of the secured wheels and the omnidirectionally moving wheels 101 are secured, can change direction to any arbitrary direction and can do so safely without weaving caused by the caster.

In the moving device, the secured wheels and omnidirectionally moving wheels 101 may be disposed at corners of a rectangular body. In such a case, supporting balance of the main body is good, as is safety during travel. Furthermore, the position of the secured wheels and the omnidirectionally moving wheels 101 allows easy access to both wheels, thereby allowing easy operation. In the moving device, two drive-transmission belts may be wrapped around the secured wheels and the omnidirectionally moving wheels 101 to form two pairs thereof. In such a case, because the secured wheels and the omnidirectionally moving wheels 101 can be made to rotate in unison, the moving device becomes four-wheel drive and has good safety and mobility. Furthermore, with four-wheel drive, the moving device can easily travel over sandy or stepped surfaces.

As another method of use, where casters are used, the casters must be disposed on outer sides of the moving device to ensure the space to change the direction of the wheels, but this is not necessary for the omnidirectionally moving wheels 101, which have a smaller width than the secured wheels and can be disposed so that the moving device becomes a trapezoidal shape. At this time, the space necessary to rotate the wheel chair or the like can be minimized. Furthermore, the moving device is not limited to having four wheels, and may have three wheels, five wheels, six wheels, or the like. In a case where the moving device has three wheels, for example, the moving device may contain one, two, or three omnidirectionally moving wheels 101.

It is desirable that the omnidirectionally moving wheel 101 according to this embodiment of the present invention moves and travels in all directions. For example, the omnidirectionally moving wheel 101 can be suitably used as the wheel in a home vacuum cleaner, a wheel chair, an all-purpose load-carrying trolley, or the like.

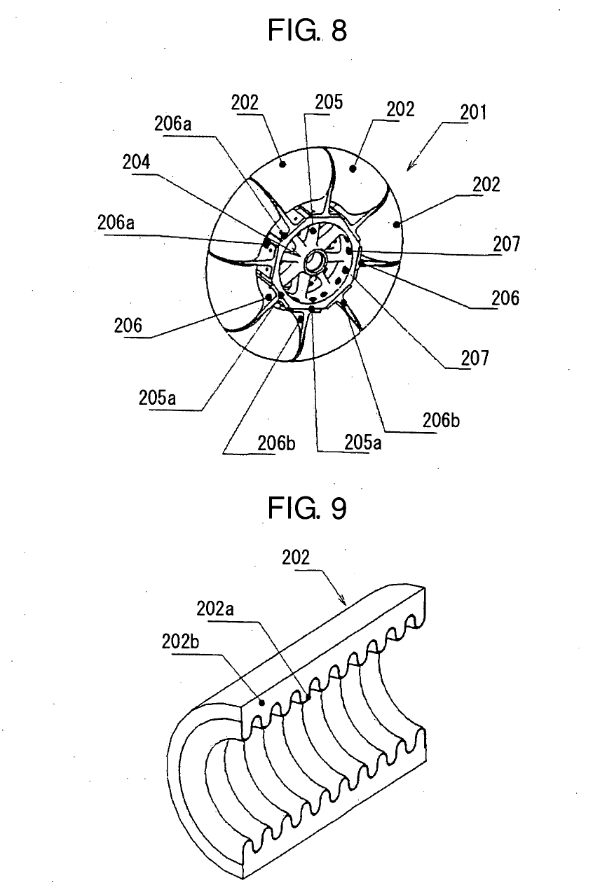

The following is a description of a second embodiment of the present invention. The second embodiment is also an omnidirectionally moving wheel, but it is proposed that the omnidirectionally moving wheel be used in a rotating transport roller such as a conveyor or the like, and therefore will be referred to as an omnidirectionally moving roller and described hereinafter. FIGS. 8 to 14 show the omnidirectionally moving roller according to this embodiment the present invention. As shown in FIGS. 8 to 10, the omnidirectionally moving roller 201 contains multiple rotating bodies 202, a wheel 204, and a rotating body support unit 206.

As shown in FIG. 9, each rotating body 202 is formed by covering with an elastic body 202b a bellows 202a that can shrink and expand in a direction of the rotational axis. The elastic body 202b is made of, for example, polyurethane, silicon rubber, foam rubber, or the like. Each rotating body 202 has strength to resist being crushed radially and also has a flexibility to allow bending of the rotational axis.

As shown in FIG. 10, a core member 203 is bent to be shaped as a cylindrical arc. The core member 203 has a diameter smaller than an internal diameter of the rotating body 202, and is inserted inside the rotating body 202 so that a gap is created between the core member 203 and an inner wall of the rotating body 202.

As shown in FIG. 8, the wheel 204 is made of metal or plastic and contains a wheel body 205 and a rotating body support unit 206. The wheel body 205 contains multiple support unit securing surfaces 205a on the outer circumference thereof. Each rotating body support unit 206 contains a securing board 206a, which is a rectangular board slightly smaller than each support unit securing surface 205a of the wheel body 205. As shown in FIG. 8, the securing board 206a of each rotating body support unit 206 is mounted and secured by a screw 207 to each support unit securing surface 205a of the wheel body 205, so that the support board 206b is perpendicular with respect to the rotating direction of the wheel body 205. Each rotating body support unit 206 is secured to the outer circumference of the wheel body 205 in a radial manner.

As shown in FIG. 10, the rotating body support unit 206 contains a cap 208 which can be attached or removed from the support board 206b. The cap 208 contains a central securing unit 208a and a rotating circumferential unit 208c disposed around the circumference of the central securing unit 208a via a bearing 208b. In the cap 208, the central securing unit 208a is attachable and removable from the support board 206b. Furthermore, an engaging projection 208e is disposed on the central securing unit 208a and functions to determine a position (stop the spinning) of the central securing unit 208a and the support board 206b in the rotational direction, thereby securing the position of the core member 203. The cap 208 is mounted on both ends of the rotating body 202 to close up the openings therein. In the cap 208, the central securing unit 208a is pressed to the core member 203 and secured by a bolt 208d and the rotating circumferential unit 208c is secured to an end of the rotating body 202, so that each rotating body 202 is structured in a manner to smoothly rotate along with the rotating circumferential unit 208c in relation to the core member 203 and the central securing unit 208a of the cap 208.

As shown in FIG. 8, in the omnidirectionally moving roller 201, each rotating body 202 is compressed in a direction of the rotational axis, bent to encircle the outer circumference of the wheel 204 in a ring-like manner, and disposed between each of the rotating body support units 206, thereby securing the central securing unit 208a of the cap 208 mounted on both ends of each rotating body 202 to the supporting board 206b. In the omnidirectionally moving roller 201, each rotating body support unit 206 supports each rotating body 206 at both ends to allow rotation and keeps each rotating body 202 bent in a cylindrical arc. Furthermore, in the omnidirectionally moving roller 201, both ends of the core member 203 are engaged with two rotating body support units 206 to keep the core member 203 bent in an arc. Therefore, each rotating body 202 can rotate centered around each rotating body's secured rotational axis extending along a plane perpendicular to the rotational axis of the wheel 204.

As an example of a structure similar to that described above, a flexible tire, which is a circular rotating body with a flexible rotational axis, has been proposed, as disclosed in Japanese Patent Application Publication No. 2005-67334. Thus, the rotating body is supported across almost the entire length of the internal diameter thereof by a short metallic cylinder with a rotational axis having no flexibility, and furthermore, the internal diameter of the short metallic cylinders is supported by a curved metallic axle. From the perspective of a load-supporting structure, it can be said that the aforementioned rotating body is such that the outer circumference of the rotating body described in Patent Documents 4 or 5 is covered with an elastic tube to alleviate the negative effect on smoothness caused by the rotation of a polygonal shape. However, because a discontinuous contour in the outer circumference of adjacent short metallic cylinders serving as support bodies is not lessened by the flexible tire and because energy lost to heat, noise, or the like during sliding of the internal diameter of the flexible tire cannot be avoided, a smooth and light-weight omnidirectional motion could not be realized.

The following is a description concerning effects of the present embodiment. In the omnidirectionally moving roller 201, because each rotating body 202 has flexibility to bend the axis of rotation, the outer circumference of the wheel 204 can be formed in a ring-like shape even where each rotating body 202 is formed in a roughly cylindrical shape. Therefore, without changing the outer diameter in a direction of the rotational axis of each rotating body 202, objects obstructing the path on which the omnidirectionally moving roller 201 travels can always be ridden over by the portion of the rotating body 202 having the largest diameter, so that the ability to ride over an obstruction can always be exhibited to the maximum amount. Through the manner described above, the omnidirectionally moving roller 201 has a high ability to ride over an obstruction in the traveled path, regardless of the position of the direction of the rotational axis of each rotating body 202.

Because each rotating body 202 is disposed in a manner to be able to rotate centered around each rotating body's secured rotational axis extending along a plane perpendicular to the rotational axis of the wheel 204, each rotating body 202 can rotate in a direction perpendicular to the rotational direction of the wheel 204. Therefore, in a case where, for example, the omnidirectionally moving roller 201 is used as a roller in a conveyor, the direction in which a transported object moves can be switched to an arbitrary direction, even where the roller is disposed in a secured manner. Furthermore, a force to transport or stop the transported object is provided by forcing driving of the roller, and the roller can easily be ejected from the conveyor line.

Because each rotating body 202 is compressed in the direction of the rotational axis, durability is increased compared to a time when tensile stress is added to each rotating body 202. Furthermore, displacement of each rotating body 202 in a direction of the rotational axis or change in the amount of bowing in the arc of the rotational axis caused by a reactive force of the transported object can be suppressed.

Because each rotating body 202 is formed by covering with the elastic body 202b the bellows 202a that can shrink and expand in a direction of the rotational axis, each rotating body 202 can be structured with a high degree of accuracy and unevenness of rotational torque can be minimized, thereby decreasing the force required for operation during travel. Because both ends are formed as a bearing support box and the bellows 202a can be used as a wall during cast molding of the elastic body 202b, the cast molding can be easily created. Furthermore, because a substrate can be used without needing to use a separating material during cast molding, adhesion of the elastic body 202b is strengthened to make the rotating body 202 with high durability. Even in a case where the elastic body 202b is damaged, the water and dust resistant sealing remains potent, giving a high degree of reliability, especially when used as a wheel.

Displacement of the rotational axis at a time when a load is added to each rotating body 202 is minimized by the rotating body support unit 206, so that the load does not affect the comfort of the ride. Furthermore, each rotating body 202 can rotate while maintaining the curvature of the rotational axis. The bent shape of the rotating body 202 can be forced into the desirable shape based on the shape of the core member 203, so that, even in a case where a heavy load is again added to each rotating body 202, excessive displacement can be suppressed by supporting the inner wall of the rotating body 202 and the negative effect on the comfort of the ride can be minimized. Furthermore, the core member 203 can prevent excessive deformation and damage of the rotating body 202. Because each rotating body 202 can be constructed in a bent shape because of the core member 203, spare parts can be prepared in advance. Therefore, in the rare case where it is necessary to replace the rotating body 202 because of damage or the like, each rotating body 202 can be easily replaced using simple tools, so that maintenance and repairs can be performed by a user, thereby ensuring quick maintenance at a reduced cost.

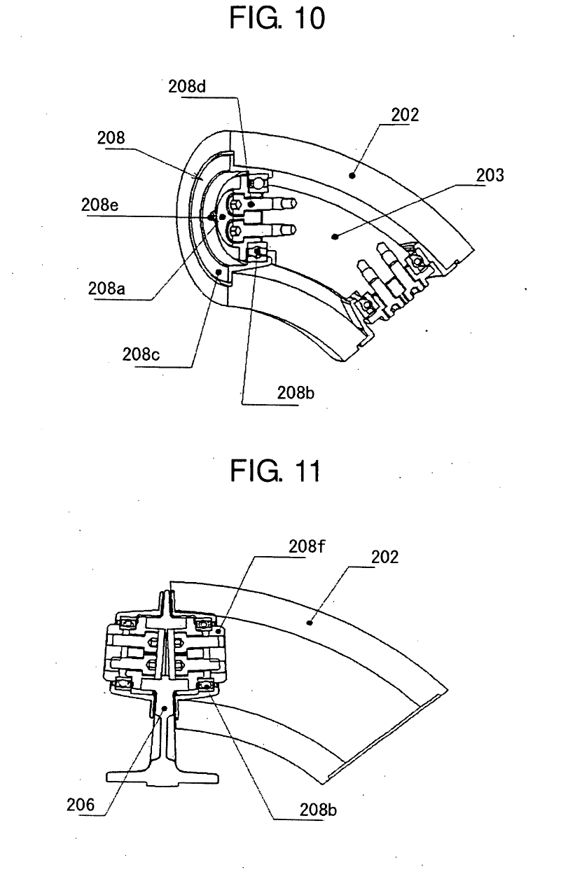

As shown in FIG. 11, the omnidirectionally moving roller 201 may contain a weighted bearing 208f instead of the core member 203. Such a structure functions sufficiently in a case where a heavy load is not to be added or in a case where the amount of displacement in the height of the axle is not intended to be limited to a certain amount even where a heavy load is added. By omitting the core member 203, the omnidirectionally moving roller 201 can be made lighter and the cost thereof can be decreased.

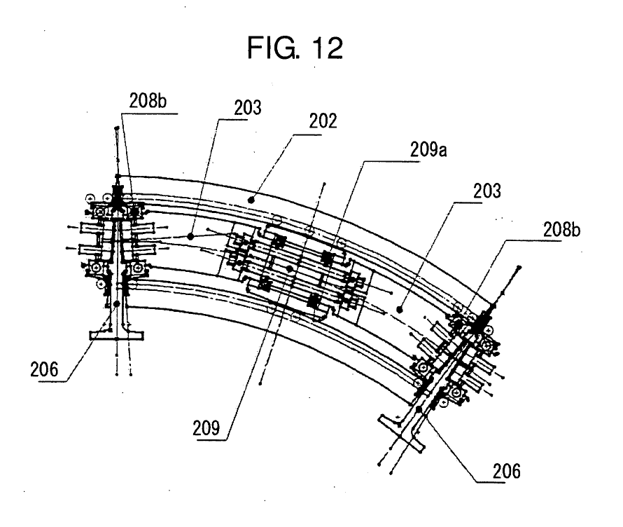

As shown in FIG. 12, in the omnidirectionally moving roller 201, the core member 203 is disposed in a prescribed location at both ends of each rotating body 202 and may contain an intermediate support unit material 209 made up of a roller bearing containing a bearing 209a to support each rotating body 202 in a manner to allow rotation. In such a case, deformation of each rotating body 202 at a time when a heavy load is added thereto is further suppressed, and energy loss to friction during sliding can be avoided. Furthermore, by forcing the each rotating body 202 into the prescribed shape at the time of construction, the shape of the outer circumference of the wheel can be reformed to a shape closely resembling a perfect circle, so that vibration during travel caused by the rotation of a polygonal shape at a time when no load is added can be reduced. By lengthening the dimensions of each rotating body 202, the number of rotating body support units 206 disposed can be decreased to improve the design and reduce the cost.

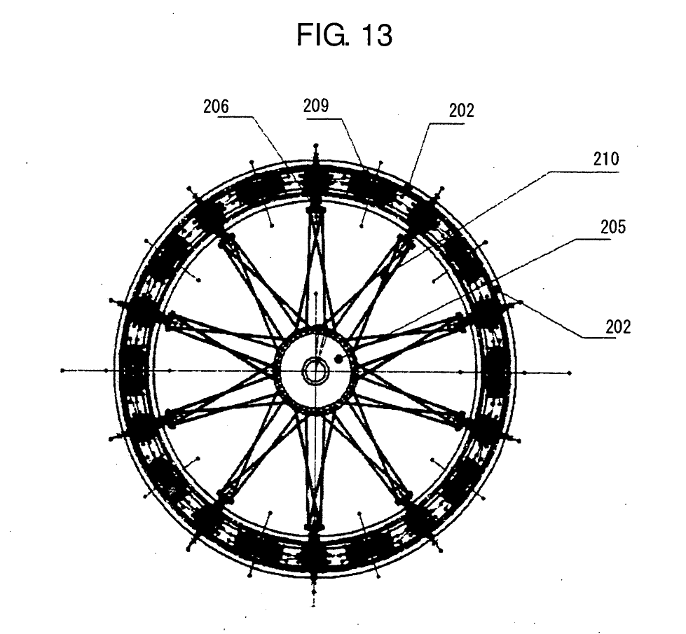

As shown in FIG. 13, in the omnidirectionally moving roller 201, the wheel 204 may contain the wheel body 205 with a small diameter located on a central axis and multiple spokes 210 connecting the wheel body 205 to the rotating body support unit 206. In such a case, at a time when the omnidirectionally moving roller 201 with a large diameter is constructed, the rotating body support unit 206 can be supported by the wheel body 205 with a small diameter and the multiple spokes 210, so that the structure can be made very light weight because the wheel body with a large diameter is not necessary. Because the rotating body support unit 206 is held and centered around the wheel 204 by the spokes 210, the series of parts formed in a ring-like shape including the core member 203, the bearings 208b, the caps 208, and the rotating body support unit 206 can be formed as a single solid ring that can bear a load by pressing and binding each part at the end surfaces in a radial direction of the wheel 204.

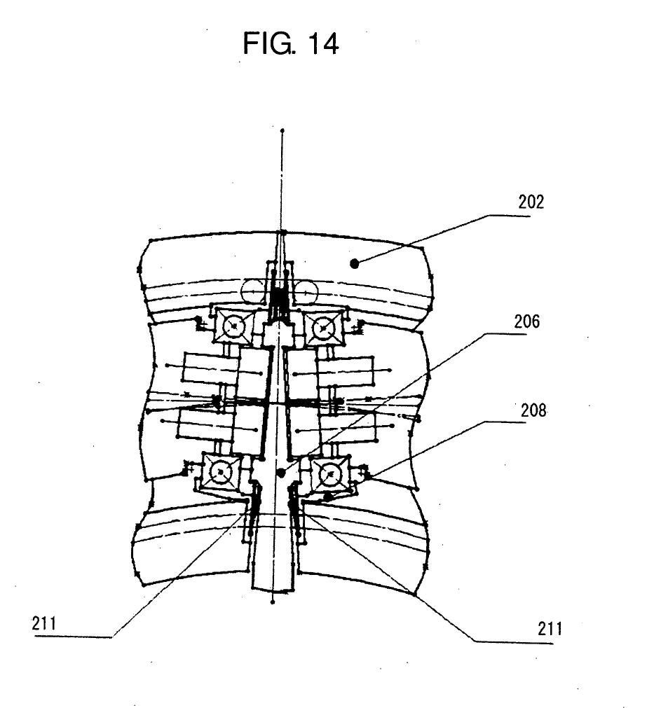

As shown in FIG. 14, the omnidirectionally moving roller 201 may contain a sealing unit 211 made of a disc spring, disposed between the securing board 206b of the rotating body support unit 206 and the cap 208 to fill the openings at both ends of each rotating body unit 202. In such a case, even where traveling over sand or gravel, the sand or gravel can be prevented from entering into the gaps or internal portions of each rotating body 202. Therefore, a condition can be prevented in which greater force is necessary for travel because of an increase in the amount of energy lost in rotation as a result of sand or gravel entering into the gaps or internal portions of each rotating body 202. Furthermore, the sealing pressure of the sealing unit 211 can be adjusted by compressing the height of the disc spring.

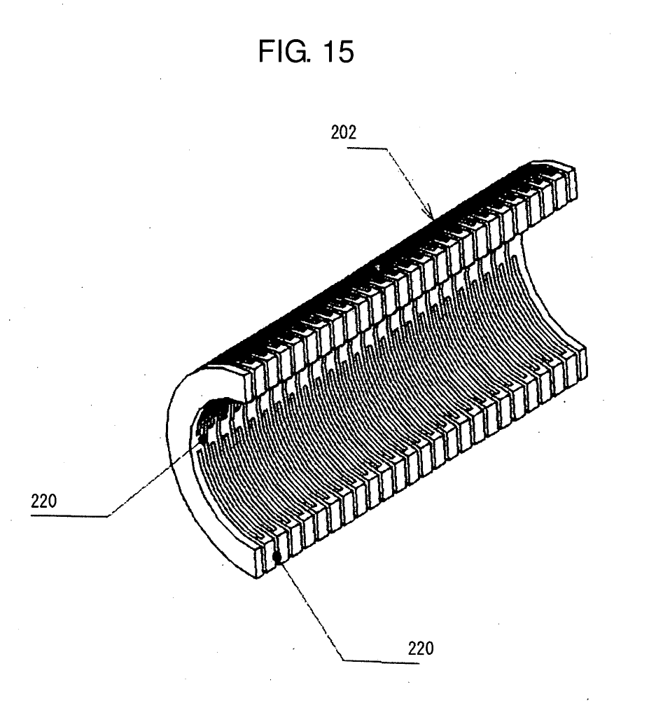

As shown in FIG. 15, in the omnidirectionally moving roller 201, each rotating body 202 may be a roughly cylindrical structure realizing radial load bearing ability and flexibility in the direction of the rotational axis by contain multiple grooves 220 interspersed opposite to each other sandwiching the cylindrical diameter, wherein each groove 220 is disposed to cut radially from an outer circumferential surface of the aforementioned cylindrical structure and is disposed to allow space between the adjacent groove 220 in a direction of the rotational axis.

As shown in FIG. 16, in the omnidirectionally moving roller 201, each rotating body 202 may be formed by covering a coil spring 221 of modified cross section wire material with, for example, an elastic body (not shown) in a roughly cylindrical shape. In such a case, because the gaps between the wires of the coil spring 221 can be enlarged, the curvature can be enlarged to a greater degree in comparison to a coil spring of circular cross section wire material. Therefore, the omnidirectionally moving roller with a small diameter can easily be constructed. Furthermore, by increasing resistance to radial displacement, the load-bearing ability is increased. Durability is also increased because adhesion is increased by the increased amount of contacting surface area between the elastic body and the coil spring 221.

As shown in FIG. 17, in the omnidirectionally moving wheel 201, in a case where the shape of the wire material is band-like, the rotating body 202 becomes a volute spring.

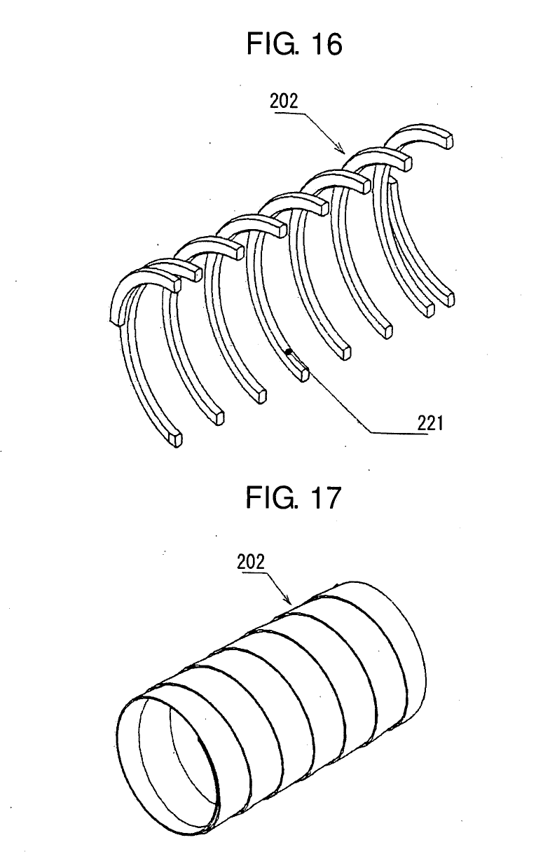

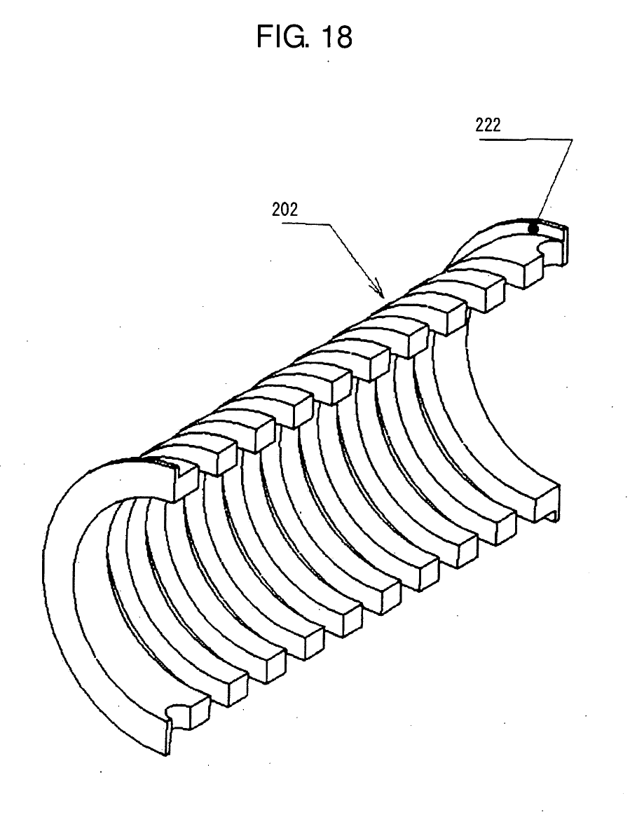

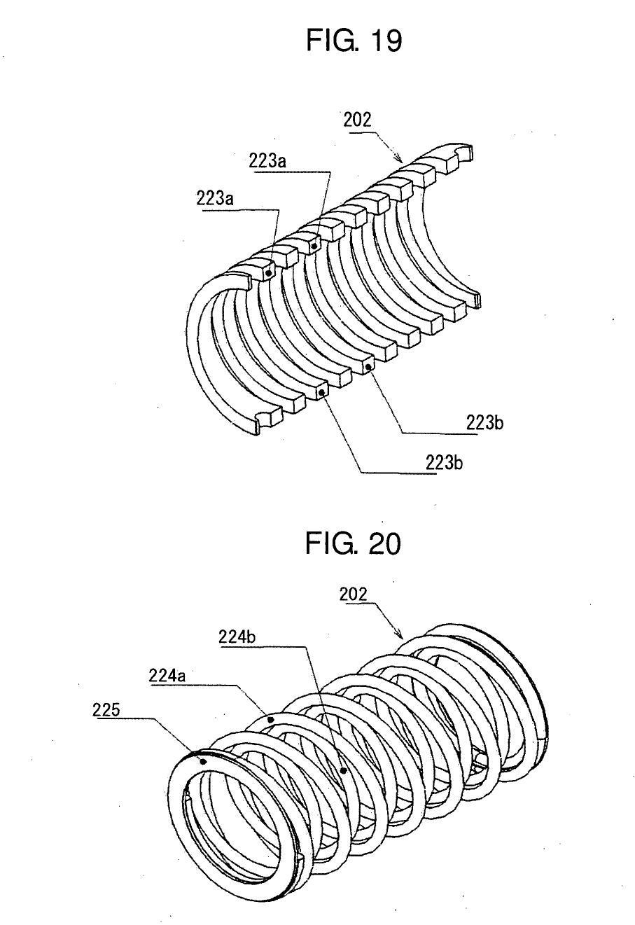

As shown in FIG. 18, in the omnidirectionally moving wheel 201, each rotating body 202 may be made of a spring processed through cutting into a coil spring shape. In such a case, compared to a wire-wound coil spring, high precision machining is possible and unevenness of rotational torque in a bent condition can be minimized to decrease the force required for operation during travel, because the coil can easily be made multi-threaded, as shown in FIG. 19. By increasing a degree of processing for both ends, the bearing fitting unit and the like can be formed as a single body, thereby increasing precision and manufacturability. In each rotating body 202, a flange 222 for pressing down both ends may be processed.

Each rotating body 202 is not limited to the process of cutting shown in FIG. 19, and may contain multiple coil springs 223a, 223b having the same diameter and pitch disposed to match the central access in a manner to allow other coil springs 223a, 223b to be disposed in the space between the wires of the previous coil springs 223a, 223b. In such a case, the coil springs 223a, 223b from which a stabilizing end portion is cut off can, for example, be staggered 180 degrees and twisted together as a secured double-banded spring to form each rotating body 202, so that the negative effect of the precision of the stabilizing end portions can be lessened, thereby minimizing the unevenness of rotational torque.

As shown in FIG. 20, in the omnidirectionally moving roller 201, each rotating body 202 may contain a coil spring 224a with a large diameter and a coil spring 224b with an outer diameter smaller than the inner diameter of the coil spring 224a with a large diameter, and the coil spring 224b with the small diameter is disposed inside of the coil spring 224a with a large diameter. In such a case, energy loss is reduced because unevenness of energy lost to rotation is cancelled out by the two coil spring 224a, 224b. A left-handed coil spring may be incorporated inside of a right-handed coil spring. Particularly, such a structure is suitable in a case where a very heavy load is used. Such a structure can be used even where there is a limit on the dimensions of the rotating body 202 or the dimensions of the material. In addition, each rotating body 202 may contain a stabilizing ring 225 at both ends.

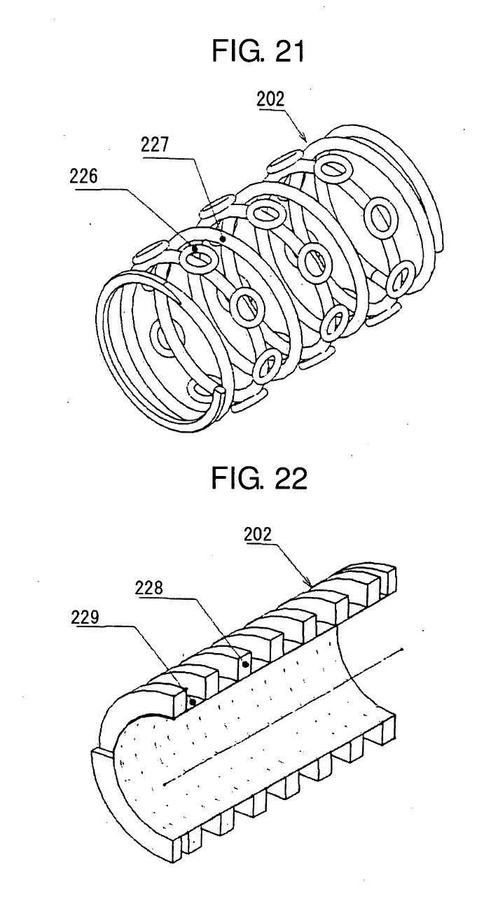

As shown in FIG. 21, in the omnidirectionally moving roller 201, each rotating body 202 may be made of a coil spring 227 containing multiple projections 226 on the outer circumference to stop slipping. In such a case, grip with the ground can be increased by the projections 226, so that slipping can be decreased, particularly on a soft surface.

As shown in FIG. 22, in the omnidirectionally moving roller 201, each rotating body 202 may contain a plastic coil spring 228 and a plastic film 229 attached in a cylindrical shape on an internal side of the coil spring 228 to cover the gaps thereof. Such a structure can be suitably used for a very heavy load.

As shown in FIG. 23, in the omnidirectionally moving roller 201, each rotating body 202 may contain a coil spring 230 and an elastic body 231 in a roughly cylindrical shape connected and secured by adhesive to cover the outer circumference of the coil spring 230.

As shown in FIG. 24, in the omnidirectionally moving roller 201, each rotating body 202 may contain, for example, a coil spring 232, the wires of which are covered with an elastic body 233. Such a structure is suitable for a wheel traveling over sandy or soft ground. That is, and therefore a large driving force can be achieved by the unevenness of the polygonal shape without vibration during travel caused by the rotation of a polygonal shape being a problem because each rotating body 202 sinks into the sandy or soft ground. In addition, a structure may be used in which a thin tube of the elastic body 233 is attached to the inner diameter of each rotating body 202 to prevent foreign objects from entering the inner diameter.

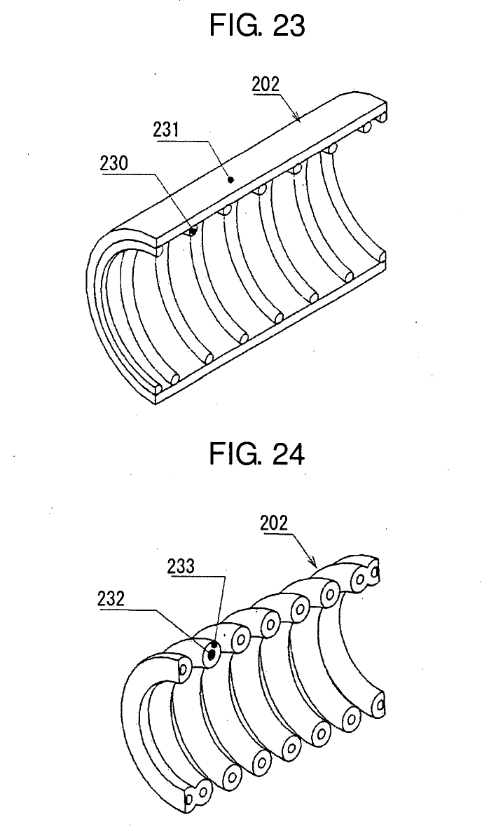

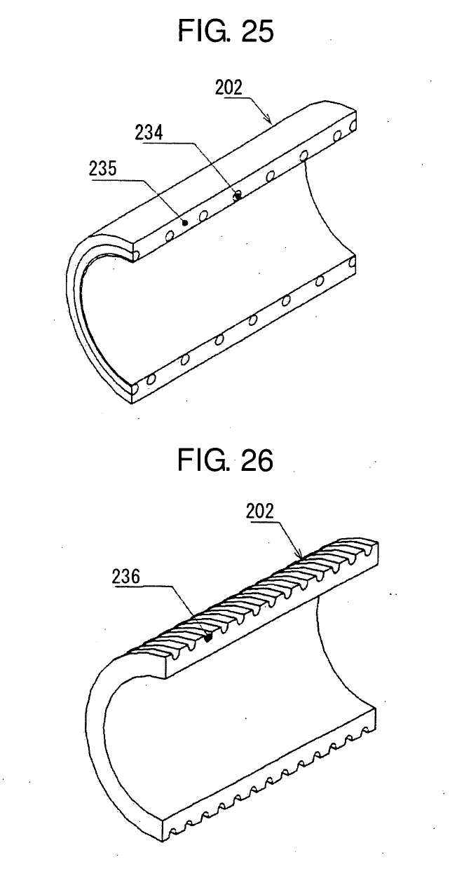

As shown in FIG. 25, in the omnidirectionally moving roller 201, each rotating body 202 may be made by, for example, covering a coil spring 234 with an elastic body 235 in a roughly cylindrical shape.

As shown in FIG. 26, in the omnidirectionally moving roller 201, each rotating body 202 made of an elastic body 235 containing furrows 236 on an outer surface. In such a case, the furrows 236 on the outer surface may be in a spiral pattern similar to the coil spring or in a ring-like shape.

As shown in FIG. 27, in the omnidirectionally moving roller 201, each rotating body 202 can be formed of, for example, a coil spring 237 covered with an elastic body 238 in a roughly cylindrical shape, the elastic body 238 having furrows 236 on the inner surface. In such a case, it is desirable that the furrows 236 be disposed in a spiral pattern between the wires of the coil spring 237 and formed as close as possible to the stabilizing end portion of the coil spring 237.

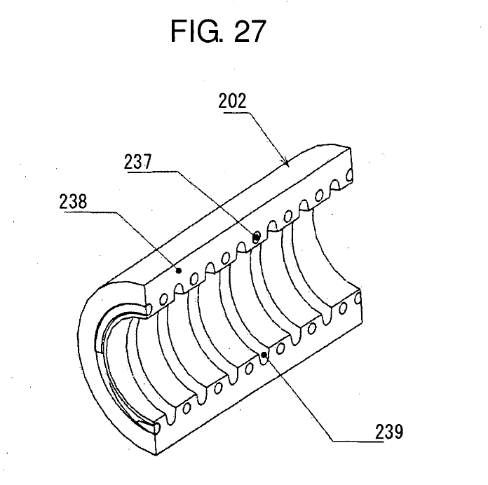

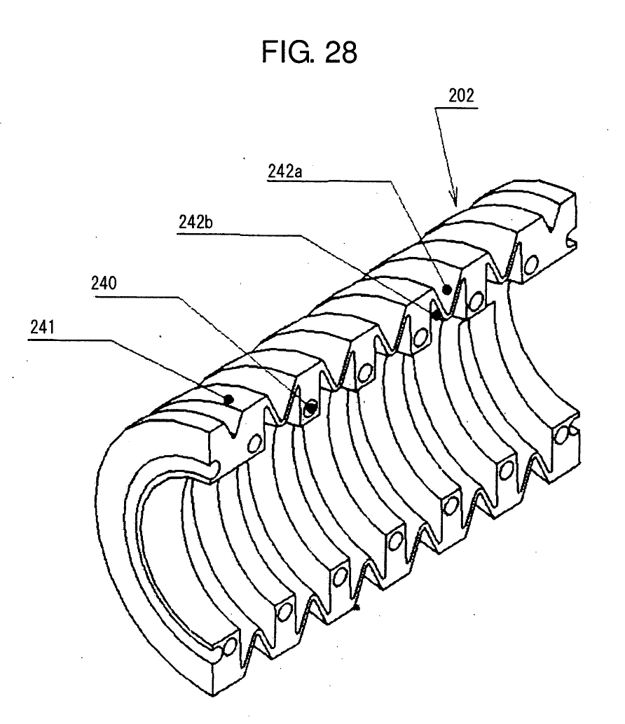

As shown in FIG. 28, in the omnidirectionally moving roller 201, each rotating body 202 may be made of, for example, a coil spring 240 covered with an elastic body 241 in a roughly cylindrical shape, the elastic body 241 containing furrows 242a, 242b on an inner and outer surface, respectively, along the gaps between the wires of coil spring 240. In such a case, the compression resisting force of the elastic body 241 can be greatly decreased by the furrows 242a, 242b, so that the energy lost during rotation can be minimized.

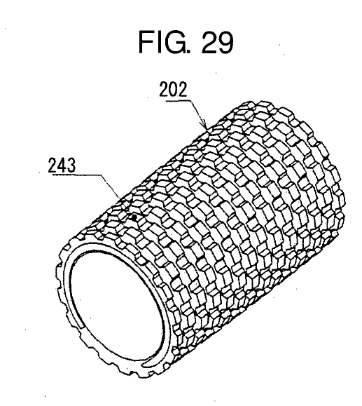

As shown in FIG. 29, in the omnidirectionally moving roller 201, each rotating body 202 may be made of an elastic body formed with bumps 243 in a tread pattern on an outer surface.

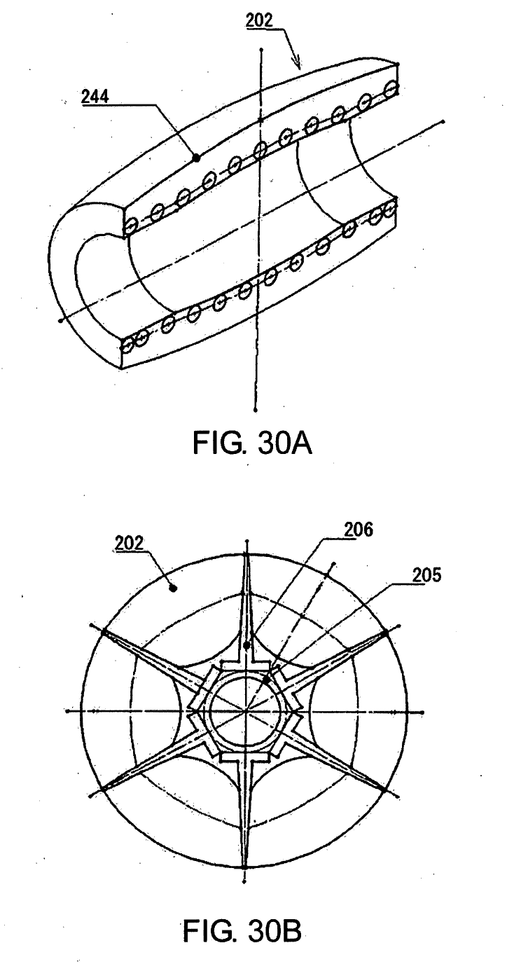

As shown in FIG. 30, in the omnidirectionally moving roller 201, each rotating body 202 may contain a side surface 244 continuously bent convexly from both ends to the center. Such a structure is easily utilized to construct the omnidirectionally moving roller 201 with a small diameter.

As shown in FIG. 31, in the omnidirectionally moving roller 201, each rotating body 202 may contain a so-called tire-shaped elastic body, which is an arch-shaped elastic body that rotates around a rotational axis with convex portion of the arch-shaped elastic body facing an outer side in relation to the rotational axis, and be a structured in a manner such that multiple tire-shaped elastic bodies, are linked in a direction of the axis of rotation thereof. In addition, a joining pin 247 is used to join the tire-shaped elastic bodies to each other. In such a case, an inner circumferential surface of the tire-shaped elastic body is formed to contain circular cavities 245 centered around the rotational axis of the tire-shaped elastic body.

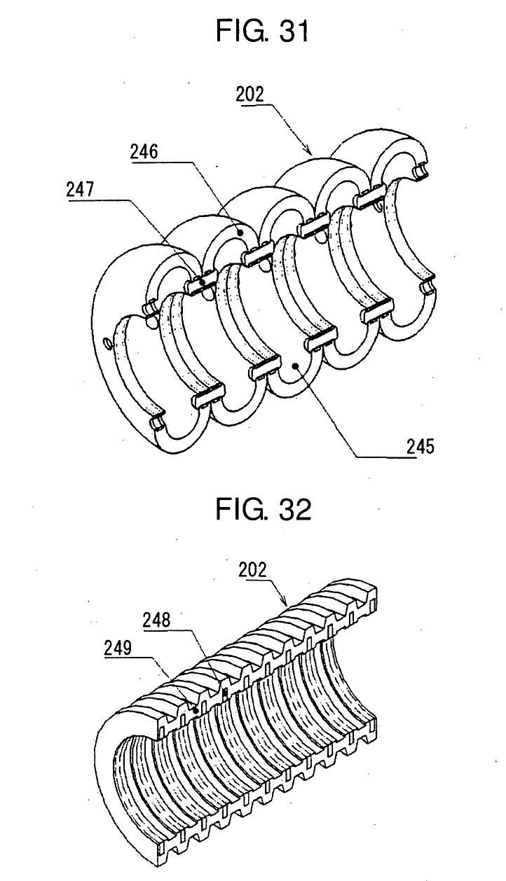

As shown in FIG. 32, in the omnidirectionally moving roller 201, each rotating body 202 may be made by joining multiple rings 248 disposed in a parallel manner with space therebetween and covering the outer circumference of each ring 248 with an elastic body 249 in a cylindrical shape.

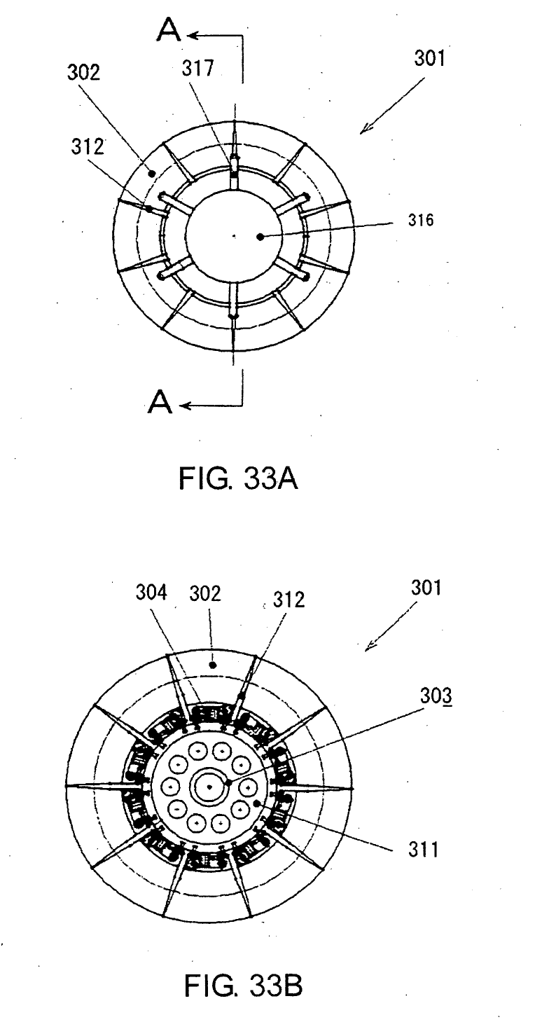

The following is a description of a third embodiment of the present invention. FIGS. 33 to 38 show an omnidirectionally moving wheel and a moving device of the present embodiment. As shown in FIGS. 33 to 36, the omnidirectionally moving wheel 301 contains multiple rotating bodies 302, a wheel 303, and a brake 304.

As shown in FIG. 33(b), the wheel 303 is made of plastic or metal and contains a wheel body 311 and multiple rotating body support units 312 secured radially on an outer circumference of the wheel body 311. Each rotating body 302 is formed by covering a structure made of a coil spring with an elastic body. The coil spring is an anisotropic structure in strength having flexibility to bend the rotational axis and resistance against bowing in a direction perpendicular to the rotational axis.

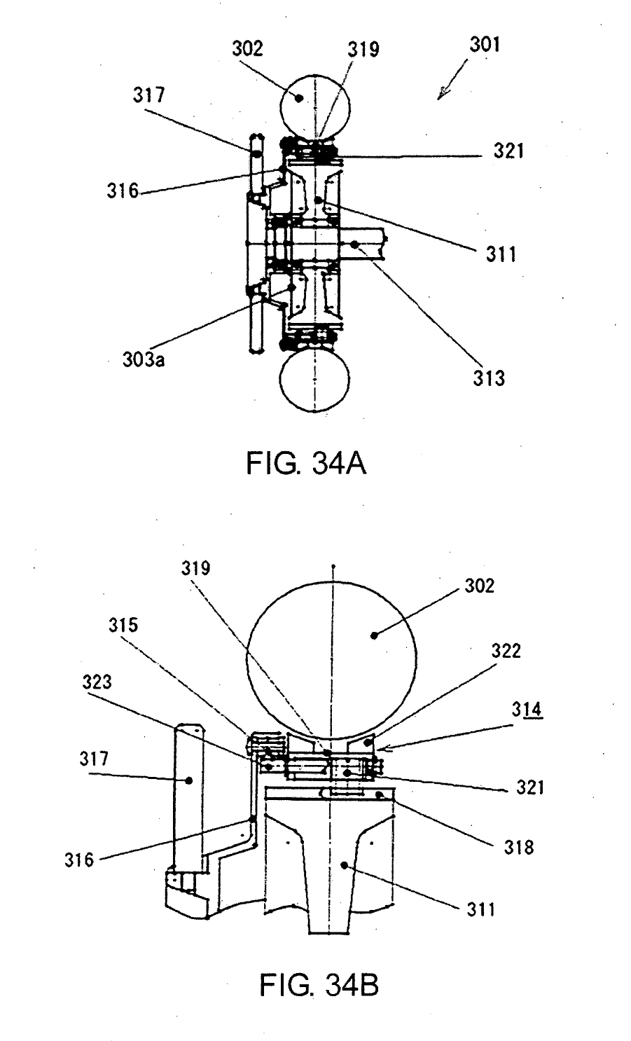

As shown in FIGS. 33 and 34, each rotating body 302 is compressed in a direction of the rotational axis thereof, bent to encircle the outer circumference of the wheel 303 in a ring-like shape, and disposed between each rotating body support unit 312. Each rotating body 302 supported at both ends by each rotating body support unit 312 in a manner such that each rotating body 302 can rotate centered around each rotating body's secured rotational axis 313 extending along a plane perpendicular to the rotational axis of the wheel 303. There is a gap between each rotating body 302 and the wheel body 311 in which each rotating body support unit 312 is disposed.

As shown in FIGS. 33 to 36, the brake 304 contains multiple brake shoes 314, a cam ring 315, a cam ring holder 316, and an operation unit 317. Each brake shoe 314 is disposed on the outer circumference of the wheel body 311 between each rotating body support unit 312. Each brake shoe 314 is disposed in the gaps between each rotating body 302 and the wheel body 311, and contains a brake unit base 318, a brake arm 319, a brake arm pivot shaft 320, a brake spring 321, a shoe unit 322, and a cam follower 323.

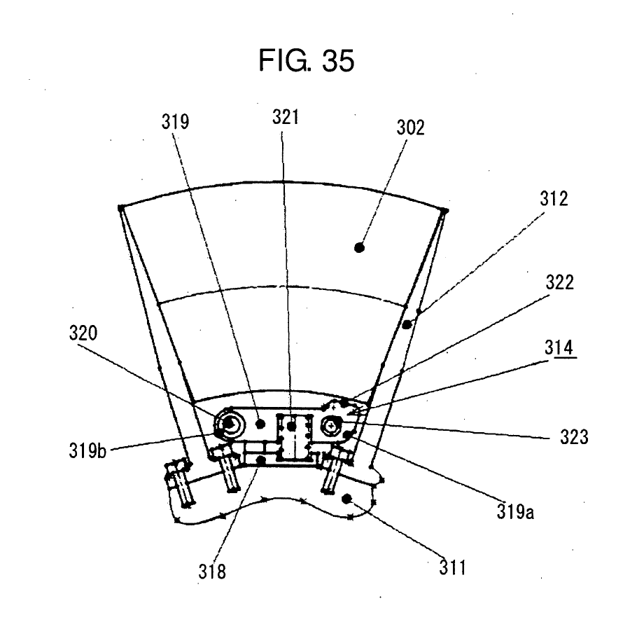

As shown in FIGS. 34 and 35, the brake unit base 318 is secured to the outer circumference of the wheel body 311. The brake arm 319 is disposed to extend in a direction of the rotational axis of each rotating body 302. Furthermore, the brake arm 319 is disposed in a manner such that one end 319a thereof is movably disposed between the wheel body 311 and each rotating body 302 and another end 319b is disposed to rotate on the brake unit base 318 through the brake arm pivot shaft 320. The brake spring 321 is disposed to join the brake unit base 318 and the brake arm 319, so that the brake arm 319 is biased to the side of the rotating body 302. The shoe unit 322 is disposed on the rotating body 302 side of the end 319a of the brake arm 319 in a manner to closely contact the outer surface of the rotating body 302. The cam follower 323 is disposed on the end 319a of the brake arm 319 to project parallel to the rotational axis 313 of the wheel 303. The cam follower 323 is disposed to project in a direction of one side surface 303a of the wheel 303.

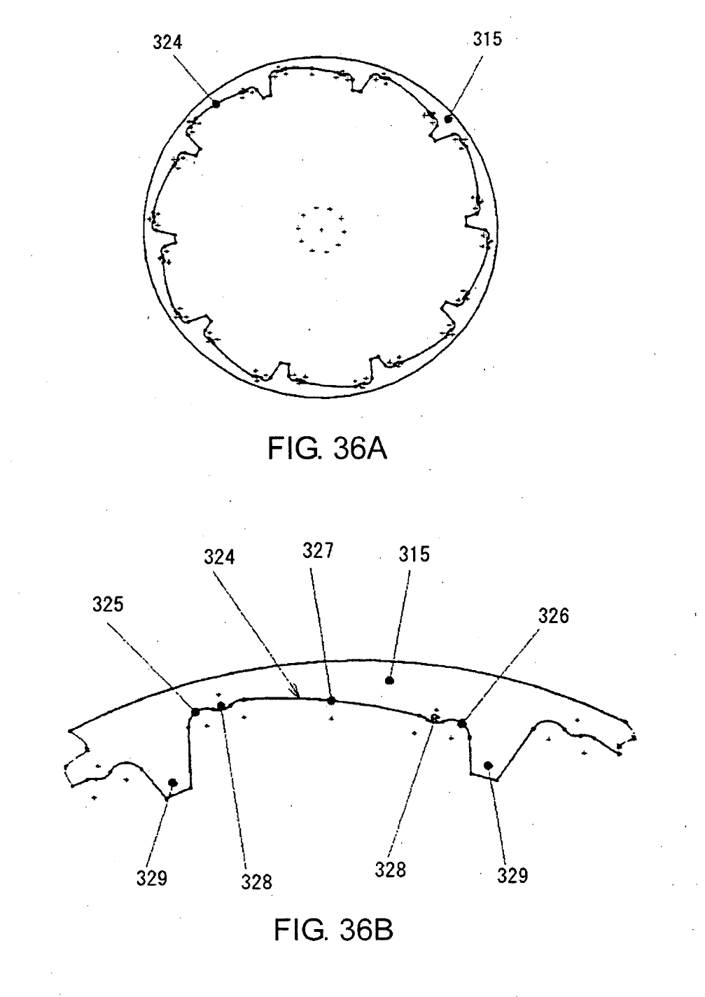

As shown in FIG. 36(a), the cam ring 315 is formed in a circular shape. The cam ring 315 is formed in a cam shape, which is a shape in which an internal cam surface 324 is repeated a number of times equal to the number of rotating bodies 302. As shown in FIG. 36(b), in the cam ring 315 contains a brake stopping lock position 325 with a large internal diameter at an end of each shape of the repeating cam surface 324, a brake releasing lock position 326 with a small internal diameter at another end, and a moving section 327, which can smoothly change an internal diameter, between the brake stopping lock position 325 and the brake releasing lock position 326. The cam ring 315 contains a projection 328 slightly projecting towards the center of the cam ring 315 and located at a border between the brake stopping lock position 325 and the moving section 327, and between the moving section 327 and the brake releasing lock position 326. Furthermore, the cam ring 315 contains a barrier unit 329 projecting in a direction of the center of the cam ring 315 and located at a border of each shape of the repeating cam surface 324.

As shown in FIG. 34, the cam ring 315 is disposed at one side surface 303a of the wheel 303. The cam ring 315 is disposed at each shape of the repeating cam surface 324 in a manner such that the cam follower 323 of each cam shoe 314 is engaged. The cam ring 315 is disposed in a manner allowing rotation around the rotating axis 313 of the wheel 303. The cam ring 315 can rotate in relation to the wheel 303, so that the cam follower can move back and forth between the brake stopping lock position 325 and the brake releasing lock position 326 via the moving section 327. In the cam ring 315, at a time when the cam follower 323 is engaged with the brake stopping lock position 325, the brake arm 319 is biased to the side of the rotating body 302 by the brake spring 321, thereby bringing the shoe unit 322 into contact with the outer surface of the rotating body 302. Furthermore, in the cam ring 315, at a time when the cam follower 323 is engaged with the brake releasing lock position 326, there is resistance to the bias of the brake spring 321, causing the brake arm 319 to be pushed back to a side of the wheel body 311, so that the shoe unit 322 is separated from the rotating body 302. Therefore, the cam ring 315 is structured in a manner such that each brake shoe 314 can be selectively moved to a stopping position contacting the rotating body 302 or to a releasing position removed from the rotating body 302, according to the angle of rotation in relation to the wheel 303.

As shown in FIGS. 33(a) and 34, the cam ring holder 316 is circular and is disposed on one side surface 303a of the wheel 303 to dispose the cam ring 315 between the wheel body 311 and the wheel 303. The cam ring holder 316 contains the cam ring 315 secured on the outer circumference thereof, and is disposed rotatably in relation to the wheel 303, along with the cam ring 315.

The operation unit 317 is made of multiple rod-like brake handles and is disposed on the cam ring holder 316. The operation unit 317 is disposed radially with gaps at various degrees along one side surface 303a of the wheel 303. The operation unit 317 is structured in a manner such that the cam ring 315 can rotate backwards and forwards in relation to the wheel 303 because the operation unit 317 can rotate the cam ring holder 316 backwards or forwards along the rotational direction of the wheel 303. In addition, the operation unit 317 uses a rod-like handle as an example, but operation may be performed using any mechanism that can rotate the cam ring holder 316 backwards and forwards, such as a wire operated by a grip handle, an actuator driven by an electromagnetic magnet, a motor, pressurized gas, or hydraulics.

The following is a description of the operation of the omnidirectionally moving wheel 301. In the omnidirectionally moving wheel 301, when the cam ring 315 is made to rotate in relation to the wheel 303 by the operation unit 317, the brake shoe 314 can be selectively moved to a stopping position or a releasing positing according to the angle of rotation of the cam wheel 315 in relation to the wheel 303 and the cam follower 323 joined to the cam ring 315. At a time when the brake shoe 314 is in the stopping position, the brake shoe 314 contacts each rotating body 302 to secure each rotating body to prevent rotation thereof centered around the rotational axis of each rotating body 302. At a time when the brake shoe 314 is in the releasing position, the brake shoe 314 is removed from each rotating body 302 to allow rotation centered around the rotational axis of each rotating body 302.

In the manner described above, because each rotating body 302 is mounted on the wheel to be selectively secured or rotatable through the brake 304, the omnidirectionally moving wheel 301 can be selected to function as a secured wheel that can only move backwards and forwards or to function as a free-moving wheel that can move in all directions, according to the condition in which the omnidirectionally moving wheel 301 is used. Therefore, in the moving device using the omnidirectionally moving wheel for all of it's wheels, for example, even in a case of a slanted road, each rotating body 302 can be secured to go straight so that the moving device does not move downward because of gravity. In the manner described above, the omnidirectionally moving wheel 301 can increase straight forward mobility while allowing safe operation.

With the omnidirectionally moving wheel 301, because each rotating body 302 has the flexibility to bend the rotational axis, each rotating body can be formed in a ring-like shape on the outer circumference of the wheel 303, even where each rotating body 302 is formed in a roughly cylindrical shape. Therefore, without changing the outer diameter of the in a direction of the rotational axis of each rotating body 302, objects obstructing the path on which the omnidirectionally moving wheel 301 travels can always be ridden over by the portion of the rotating body 302 having the largest diameter, so that the ability to ride over an obstruction can always be exhibited to the maximum amount. Through the manner described above, the omnidirectionally moving wheel 302 has a high ability to ride over an obstruction in the traveled path, regardless of the position of the direction of the rotational axis of each rotating body 302.

Because each rotating body 302 is disposed in a manner to be able to rotate centered around each rotating body's secured rotational axis 313 extending along a plane perpendicular to the rotational axis of the wheel 303, each rotating body 302 can rotate in a direction perpendicular to the rotational direction of the wheel 303, so that the direction of motion can be changed to an arbitrary direction even where the axle is secured. The space required for a caster to change the direction of the motion of the wheel is not necessary and the diameter of the wheel can be enlarged to increase mobility over inhospitable ground. Furthermore, a driving mechanism can be easily incorporated because the axle position does not change, and mobility can be further increased in such a case.

Because each rotating body 302 is bent to encircle the outer circumference of the wheel 303 in a ring-like manner, the omnidirectionally moving wheel 301 can achieve point contact with the ground, so that mobility is achieved even where the traveled surface is not continuous and smooth, such as on uneven inhospitable ground or curved surfaces. Because each rotating body 302 is compressed in the direction of the rotational axis, durability is increased compared to a time when tensile stress is added to each rotating body 302. Furthermore, displacement of each rotating body 302 in a direction of the rotational axis or change in the amount of bowing in the arc of the rotational axis caused by a reactive force of the ground can be suppressed.

In the omnidirectionally moving wheel 312, displacement of the rotational axis at a time when a load is added to each rotating body 302 is minimized by the rotating body support unit 312, so that the load does not affect the comfort of the ride. Furthermore, each rotating body 302 can rotate while maintaining the curve of the rotational axis.

The omnidirectionally moving wheel 301 is very effective when used as the wheel in, for example, a sales cart used inside trains that must move safely up and down a narrow isle while sometimes moving to the side to avoid an obstruction, a transport platform used inside a factory that must assume difficult positions to transfer shipments of goods, a wheel chair selected for good workability such as being able to move sideways a small amount when facing a desk, or the like.

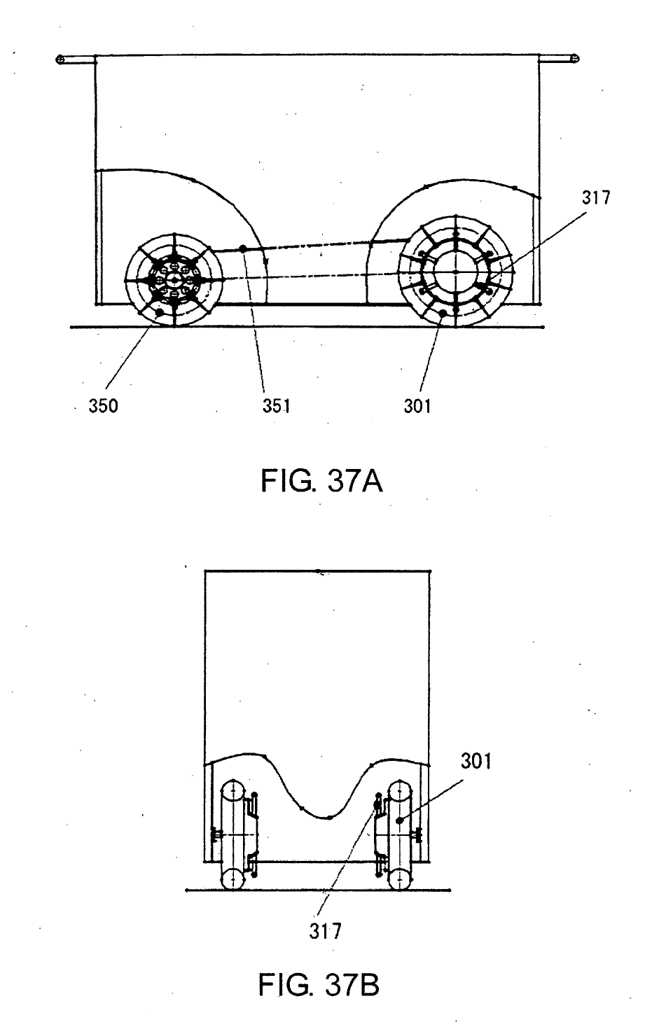

In a case where the omnidirectionally moving wheel is used in a sales cart used inside trains, as shown in FIG. 37, the sales cart contains back wheels made of the omnidirectionally moving wheel 301, front wheels made of an omnidirectionally moving wheel 350 which do not have brakes 304, and a driving force transfer belt 351 wrapped around the corresponding front and back wheels. Through this structure, because it is not necessary to change position of the wheels 301, 350, a wheel with a large diameter can be equipped without enlarging the occupied space as a caster would, thereby allowing four-wheel drive, so that the sales cart to easily ride over uneven surfaces such as the covered area joining adjacent train carriages. Even where wheels with large diameters are used, sufficient space to load products to be sold can be ensured. Furthermore, safety is ensured because the wheels 301, 350 are housed under the cover of the sales cart to prevent protrusion. Even where the width of the wheels are limited because of the width of the isle or the like, the effective width of ground contact of the wheels 301, 350 is larger than that of a caster, which increases safety by providing stability and making the sales cart more difficult to tip over. At a time when passing a person moving through the isle, the sales cart can easily move to the side to allow sufficient space. During storage, the sales cart can be pulled over and pushed flat against a wall to save space.

In a case where the omnidirectionally moving wheel is used in a meal service cart on an airplane, the meal service cart can be easily stored in a prescribed storage space. In a case where the omnidirectionally moving wheel is used in a transport platform in a factory, the transport platform can fit perfectly into a prescribed transfer position without a difficult position adjustment through backwards and forwards motion. Furthermore, storage ability in a truck bed, elevator, carrier machine, or the like is increased.

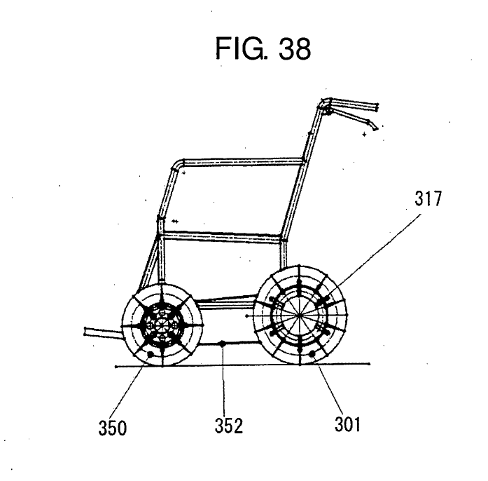

In a case where the omnidirectionally moving wheel is used in a wheel chair as shown in FIG. 38, for example, the wheel chair contains back wheels made of the omnidirectionally moving wheel 301, front wheels made of the omnidirectionally moving wheel 350 which do not have brakes 304, and the driving force transfer belt 351 wrapped around the corresponding front and back wheels. Through such a structure, a correct work posture can be maintained during deskwork because the wheel chair can easily move slightly to the side, so that a user does not become stiff or tired. In an elevator or the like the wheel chair can be placed against a wall, so that the user does not feel that they are taking up too much space. Furthermore, physically useless space can be reduced, so that it is not necessary to reposition the wheel chair to enter into a narrow entrance. In addition, movement indoors becomes easier, allowing the user to relax.

What is claimed is:

1. An omnidirectionally moving wheel comprising multiple rotating bodies and a wheel, wherein each rotating body has a flexibility to be able to bend a rotational axis, is bent to encircle an outer circumference of the wheel in a ring-like shape, and is compressed in a direction of the rotational axis of each rotating body to be disposed on the wheel in a manner to allow rotation centered around each rotating body's secured rotational axis extending along a plane perpendicular to the rotational axis of the wheel.

2. The omnidirectionally moving wheel according to claim 1, wherein each rotating body has resistance to radial bowing and has the flexible rotational axis.

3. The omnidirectionally moving wheel according to claim 1, wherein each rotating body is made of a coil spring covered with an elastic body, and wherein the wheel comprises a rotating body support unit supporting each rotating body in a rotatable manner while securing a position of both ends of each rotating body.

4. The omnidirectionally moving wheel according to claim 3, wherein the rotating body is made of the coils spring covered with the elastic body in a cylindrical shape.

5. The omnidirectionally moving wheel according to claim 1, wherein each rotating body is disposed such that an outer side surface thereof joins with an outer side surface of an adjacent rotating body.

6. The omnidirectionally moving wheel according to claim 3, comprising multiple core members, the omnidirectionally moving wheel wherein:
each rotating body is made of a cylindrical body;
each core member is inserted into an internal portion of each, rotating body; and
both ends of each rotating body are connected to the rotating body support unit.

7. The omnidirectionally moving wheel according to claim 1, wherein the wheel includes multiple boards filling a gap between the two adjacent rotating bodies.

8. The omnidirectionally moving wheel according to claim 3, wherein:
the wheel is made of a wheel body and multiple rotating body support units;
each rotating body is made of a cylindrical body;
each rotating body support unit is secured radially on an outer circumference the wheel body and is disposed between each set of the two adjacent rotating bodies to support each rotating body to allow rotation at an internal end portion thereof.

9. The omnidirectionally moving wheel according to claim 3, wherein the rotating body is made of the coil spring covered with the elastic body in a cylindrical shape, and comprises furrows in an internal surface of the cylindrical shape along gaps of the coil spring.

10. The omnidirectionally moving wheel according to claim 1, wherein the rotating body comprises a surface of the cylindrical shape having, from an end portion to a central portion, a surface continuously bent convexly or a surface in which the central portion is continuously bent convexly and both ends are fattened to form a concave shape.

11. The omnidirectionally moving wheel according to claim 1, wherein each rotating body comprises an anisotropic structure in strength having flexibility and resistance to bowing in a direction perpendicular to the rotational axis.

12. The omnidirectionally moving wheel according to claim 11, wherein the structure included in the rotating body is made of a bellows that can expand and contract in a direction of the rotational axis.

13. The omnidirectionally moving wheel according to claim 11, wherein the structure included in the rotating body is a roughly cylindrical shape and comprises multiple grooves interspersed opposite to the cylindrical diameter, where each groove is disposed to cut radially from an outer circumferential surface of the structure and is disposed to allow space between the adjacent groove in a direction of the rotational axis.

14. The omnidirectionally moving wheel according to claim 11, wherein the structure included in the rotating body is made of a coil spring of a modified cross section wire material.

15. The omnidirectionally moving wheel according to claim 11, wherein each rotating body is made by covering a wire material of the structure with an elastic body.

16. The omnidirectionally moving wheel according to claim 11, wherein the structure included in the rotating body is made of a spring formed in a shape of a coil spring by cutting work.

17. The omnidirectionally moving wheel according to claim 11, wherein the structure included in the rotating body comprises multiple coil springs having the same diameter and pitch disposed to match the central axis in a manner to allow other coil springs to be disposed in the space between the wires of the aforementioned coil springs.

18. The omnidirectionally moving wheel according to claim 11, wherein the structure included in the rotating body is made of a coil spring with a large diameter and a coil spring with an outer diameter smaller than the inner diameter of the coil spring with a large diameter, where the coil spring with the small diameter is disposed inside of the coil spring with the large diameter.

19. The omnidirectionally moving wheel according to claim 11, wherein the structure included in the rotating body includes multiple projections on the outer circumference to stop slipping.

20. The omnidirectionally moving wheel according to claim 11, wherein the structure included in the rotating body comprises a plastic coil spring and a plastic film attached in a cylindrical shape on an internal side of the coil spring to cover the gaps thereof.

21. The omnidirectionally moving wheel according to claim 11, wherein the structure included in the rotating body is made of a coil spring.

22. The omnidirectionally moving wheel according to claim 21, wherein the rotating body is made of the structure and an elastic body having resilience against a ground surface.

23. The omnidirectionally moving wheel according to claim 22, wherein the rotating body is made by covering an outer circumference of the structure with the elastic body in a roughly cylindrical shape.

24. The omnidirectionally moving wheel according to claim 22, wherein each rotating body is made by covering the structure with the elastic body in a roughly cylindrical shape.

25. The omnidirectionally moving wheel according to claim 23, wherein the rotating body includes furrows on an outer surface of the elastic body.

26. The omnidirectionally moving wheel according to claim 24, wherein the rotating body includes furrows on at least one of an outer surface or an inner surface of the elastic body.

27. The omnidirectionally moving wheel according to claim 11, wherein the rotating body includes a bumpy tread pattern formed on an outer surface of the elastic body.

28. The omnidirectionally moving wheel according to claim 1, wherein:
the rotating body is formed by covering a flexible structure with an elastic body in a roughly cylindrical shape;
the rotating body includes furrows disposed along the gaps in an inner wall of the elastic body; and
the furrows are disposed circumferentially along an outer surface in a spiral pattern.

29. The omnidirectionally moving wheel according to claim 1, wherein the rotating body comprises a surface having, from an end portion to a central portion, a surface continuously bent convexly or a surface in which the central portion is continuously bent convexly and both ends are fattened to form a concave shape.

30. The omnidirectionally moving wheel according to claim 1, wherein the rotating body is made of an elastic body having furrows on at least either an outer side or an inner side.

31. The omnidirectionally moving wheel according to claim 1, wherein the rotating body is a structure made by joining multiple tire-shaped elastic bodies in a direction of the axis of rotation thereof, and, in such a case, an inner circumferential surface of the tire-shaped elastic body is formed to include circular cavities centered around a rotational axis of the tire-shaped elastic body.

32. The omnidirectionally moving wheel according to claim 1, wherein each rotating body is made by joining multiple rings disposed in a parallel manner with space therebetween and covering the outer circumference of each ring with an elastic body in a cylindrical shape.

33. The omnidirectionally moving wheel according to claim 1, wherein the wheel comprises a rotating body support unit for supporting each rotating body at both ends in a rotatable manner.

34. The omnidirectionally moving wheel according to claim 33, wherein a core member is inserted into an internal portion of each rotating body, and both ends of each rotating body are connected to the rotating body support unit.

35. The omnidirectionally moving wheel according to claim 34, wherein the core member is disposed in a prescribed location at both ends of each rotating body, and includes an intermediate support unit material to support each rotating body in a manner to allow rotation.

36. The omnidirectionally moving wheel according to claim 34, wherein the wheel comprises a wheel body with a small diameter located on a central axis and multiple spokes connecting the wheel body to the rotating body support unit.

37. The omnidirectionally moving wheel according to claim 11, including a sealing unit to fill openings at both ends of each rotating body unit.

38. The omnidirectionally moving wheel according to claim 11, wherein the rotating body includes a brake, which is mounted on the wheel in a manner to selectively secure or rotate each rotating body.

39. The omnidirectionally moving wheel according to claim 1, wherein the rotating body includes a brake, which is mounted on the wheel in a manner to selectively secure or rotate each rotating body.

40. The omnidirectionally moving wheel according to claim 38, wherein:
the brake comprises multiple brake shoes, a cam ring, and an operation unit;
each brake shoe includes a cam follower and is disposed on an outer circumference of the wheel in a manner allowing movement between a stopped position contacting each rotating body and a released position separated from each rotating body;
the cam ring is disposed on the wheel in a manner allowing rotation around a rotational axis of the wheel, is joined to each cam follower, and has a cam shape that can selectively move the brake shoe between the stopped and released positions according to a degree of rotation in relation to the wheel; and
the operation unit is disposed to be able to rotate the cam ring in relation to the wheel.

41. A moving device, including on a main body the omnidirectionally moving wheel according to claim 1.

42. A carrying device for carrying goods, including on a main body the omnidirectionally moving wheel according to claim 1.

43. A massage device, including on a main body the omnidirectionally moving wheel according to claim 1.

44. A moving device comprising a main body, a pair of secured wheels, and at least one or more omnidirectionally moving wheel according to claim 1, the moving device wherein the secured wheels are mounted rotatably to the main body on a secured axial direction and the omnidirectionally moving wheel is rotatably mounted on the main body to support the main body along with the secured wheels.

45. The moving device according to claim 41, wherein a secured wheel and the omnidirectionally moving wheel are disposed at corners of a rectangular body.

46. The moving device according to claim 41, wherein two transfer belts are wrapped around a secured wheel and the omnidirectionally moving wheel to form two pairs thereof.
